(19) United States
(12) Patent Application Publication
(10) Pub. No.: US 2007/0125475 A1
(43) Pub. Date: Jun. 7, 2007

(54) Handheld tape applicator and components thereof, and their methods of use

(75) Inventors: Federico R. Cecilio, Watkinsville, GA (US); Brian K. Cooley, Buford, GA (US); Spencer Lee, Dacula, GA (US); Joel F. Barker, Townville, SC (US); Jianhua Pu, Bishop, GA (US)

Correspondence Address: Carlos Nieves, Esq.;Huber Engineered Woods LLC, c/o J.M. Huber Corp., 333 Thornall Street, Edison, NJ, 08837, US

(73) Assignee: Huber Engineered Woods LLC, Charlotte, NC (US)

(21) Appl. No.: 11/438,366

(22) Filed: May 23, 2006

Related U.S. Application Data
(63) Continuation-in-part of application No. 11/293,101, filed on Dec. 5, 2005.

(51) Int. Cl. E04F 13/00; B32B 37/00; B44C 7/00

(52) U.S. Cl. 156/71; 156/577; 156/579; 156/378

(57) ABSTRACT

A hand-grippable adhesive tape applicator is provided for building construction and other environments. Stabilization brace and pressure feedback features are included which provide improved tape application performance. Static dissipative shield components and slip-resistant nubs for the applicator frame are also provided.

This patent application claims priority from and is a continuation-in-part of U.S. application Ser. No. 11/293,101, which was filed Dec. 5, 2005, and which is hereby incorporated by reference in its entirety.

### FIELD OF THE INVENTION

This invention relates to devices for applying adhesive tape material, and particularly to heavy duty tape applicators for applying adhesive tape to building structures or other surfaces, including components and methods of use thereof.

### BACKGROUND OF THE INVENTION

The roof and wall structures of residential or commercial buildings are typically constructed by attaching several structural panels to the rafters of an underlying supporting structural frame. The panels are most often placed in a quilt-like pattern with the edge of each panel contacting the edges of adjacent panels so as to form a substantially continuous flat surface atop and surrounding the structural frame. In the case of roofs, a water barrier layer, such as felt paper, is then applied over the panels before the installation of shingles, tiles, shakes, or other outer roofing materials. The use of felt paper has many drawbacks including, but not limited to, the extensive labor needed to apply it and its susceptibility to wind damage before the installation of an outer layer of shingles or other roofing material thereon.

Felt paper, typically supplied in roll form, has been applied manually, or using devices such as a so-called roofing machine (e.g., see U.S. Pat. No. 907,731), which usually includes a wheeled frame which is pulled or pushed across the roof by an operator. The frame often carries a roll of felt paper on a storage roller, and a pressure roller rolls along the roof surface and presses the felt web dispensed from the storage roller against the previously laid down roofing layer. Also, a roof surface often is irregular or uneven. Pressure rollers were suggested that should press against felt paper with pressure along the width of the pressure roller while conforming the layer of felt paper to an uneven contour of a roof surface being covered. Roofing machines having frame, support roll, handle, and a deformable pressure roller configuration also have been proposed (e.g., see U.S. Pat. No. 4,460,433). These prior roofing machines are not designed to be handheld during their operation. The need to haul a relatively bulky machine on and off roofs is very inconvenient. Also, bulky roofing machines may not be convenient for use at edges of roofs and/or around upright obstacles commonly encountered on a roof such as chimneys and vent pipes. In addition, roofs having steeper pitch may not be conducive for operation of a roofing machine thereon needing an operator to maintain a generally upright stance. Also, the prior roofing machines generally can not also be used for other significant construction site tasks such as wall construction, and so forth.

Water-resistant seam tape applied to seams between adjoining roofing or wall panels by bare hand as part of a water-proofing scheme. The process is slow, cumbersome and laborious. A seam tape applicator for applying a seam tape to an edge of a membrane sheet has been described including a frame which can be pushed via handle by an operator without bending over (e.g., see U.S. Pat. Appln. Publ. No. 2004/0129387 A1). The applicator applies a seam tape to a surface in such a way that an upper release liner is not separated from the seam tape until after the tape has already been applied to the lower edge of a seam.

For wall installations in building construction, an extra step must typically be added to the installation process to prevent liquid moisture and air from passing through the wall. Specifically, constructing a wall with a weather barrier requires not only that panels be attached to framing members, but also a house wrap is unrolled and spread over the walls. The house wrap is attached to the sheathing panels with staples or button cap nails and fenestration openings for windows or doors must be cut out of the wrap and the flaps from these openings folded back and stapled down. The house wrap is often difficult to install because it is typically in wide, e.g., nine feet wide, rolls, which can be difficult to maneuver by workers on scaffolding or in windy conditions. To help prevent mold growth, a drainage plane is optionally applied. The use of the moisture barrier wrap, or a drainage plane increases cost due to increased material and labor cost.

Handheld tape dispensers and applicators have been in widespread use for many years for relatively light-duty applications. For instance, prior tape dispensers and tape applicators have been used for dispensing adhesive tapes such as masking tapes, packaging tapes, cosmetic tapes, surgical tapes, and electrical tapes, etc. Tape dispensers and applicators have been used to dispense selected lengths of adhesive materials in strip form from a roll of tape. In many instances, the dispensers are used to dispense a single-sided adhesive tape having pressure-sensitive adhesive applied to only one face thereof, which tapes usually can be unreeled from a supply roll and directly applied to a surface without the need for elaborate dispensing devices. However, the use of lined adhesive tapes is desirable in many applications. Prior tape dispensing devices have been described for dispensing a strip of pressure-sensitive adhesive tape supported on a release liner. These tape dispenser devices have included configurations having a take-up spool for collecting release liner, which is driven by the unwinding of tape from a supply spool assembly (e.g., see U.S. Pat. Nos. 3,969,181; 4,570,868; and 4,718,971).

Drive mechanisms for such self-driven devices ideally should provide the requisite mechanical functionality without overly burdening the handheld device with additional bulk and weight. Tape dispensing devices fitted with pistol grips have increased balance considerations as the predominant mass of the dispenser often will be supported above the gripping hand. Meeting all of these concerns can be expected to become even more challenging as size and weight of an adhesive tape roll is increased.

Adequate pressure is required to create a seal with pressure-sensitive tape. Where handheld tape applicator devices are used, the pressure needed to create a seal is a force supplied by the user or installer. Tapes requiring high application pressures are burdensome and tiring, especially in more rigorous work environments such on those involving seam applications for inclined roof construction or wall construction using ladders, since they require a high user-applied application force. Moreover, the relatively high application pressures commonly applied and required with conventional tape applicator devices do not necessarily result in water-tight seals.

The present investigators have recognized a need for improved handheld devices suitable for application of adhesive sealing tapes in the construction of roofs, walls, or other building structures. As will become apparent from the descriptions that follow, the inventive device and methods of its use addresses these needs as well as providing other advantages and benefits.

### SUMMARY OF THE INVENTION

The invention provides a hand-held adhesive tape applicator for use in building construction and other environments.

In one embodiment, a hand-held adhesive tape applicator device is provided for applying an adhesive tape material, comprising a frame extending in a longitudinal direction; an applicator roller assembly including an applicator roller extending generally transverse to said longitudinal direction; a tape supply spool assembly; release liner take-up reel assembly; a gear train drivingly connecting the tape supply spool assembly and release liner take-up reel assembly; a first hand grip mounted to a base portion of the frame; a stabilization brace, extending in a direction generally parallel to and laterally spaced from said longitudinal direction of the frame connecting (a) a first lateral side of the applicator roller assembly located opposite the second lateral side thereof located nearest the frame to (b) the base portion of the frame, effective to reduce bending of the applicator roller during tape application; and a pressure feedback assembly including a reciprocally translatable interference component operable to interact with a gear associated with the drive means to generate noise when pressure applied at the applicator roller is below a predetermined threshold pressure and to cease interaction with the gear and noise generation when the threshold pressure is met or exceeded.

The applicator roller is rotatably mounted to the frame, and it is adapted to press adhesive tape material comprising an adhesive layer carried on a release liner against a substrate. The tape supply spool assembly is rotatably mounted to the frame, and it is adapted to support a roll of the adhesive material, and unreel adhesive material to the applicator roll as the applicator roll moves against a substrate with the adhesive layer in contact therewith. The release liner take-up reel assembly is also rotatably mounted to the frame. It is adapted to take-up release liner, if lined adhesive tape is used, after the adhesive layer is separated therefrom. The drive means may comprise a gear train wherein the rotation of the supply tape spool is transmitted to the take-up reel assembly. The gear train may comprise a first gear receiving force transmitted from rotation of the supply spool assembly and a second gear receiving the force and transmitting it to rotate the take-up reel assembly, and may include at least one intermediate gear drivingly interconnected between the first and second gears to transmit the force therebetween. A second hand grip may be mounted at an opposite upper portion of the frame to permit grasping of the device with both hands at the same time during dispensing of tape.

The pressure feedback assembly alerts the user if inadequate pressure is being exerted to properly adhere and seal the tape to a surface. Such feedback informs and encourages the user to apply appropriate pressure, resulting in higher-quality taped joints. In one particular embodiment, in respect of the pressure feedback assembly, the interference component projects towards and reciprocally into the path of and between gear teeth of a gear driving the take-up reel assembly, and which is supported by an integral extension arm extending in a direction towards the pressure roller. The interference component contacts gear teeth of the gear in manner effective to generate an audible signal unless force applied at the pressure roller meets or exceeds a predetermined threshold pressure. This configuration allows for an increased build-up of potential energy in the interference component/gear teeth area. Upon release (e.g., when interference component strikes and disengages from a rotating gear tooth), the increased vibration in turn increases the sound volume that is created. In another particular embodiment, the interference component comprises a rectilinear member having a rounded distal tip wherein the rectilinear member extends from an extension arm at an approximately 90 degree angle relative to the recesses between adjacent gear teeth of the take-up reel assembly gear. The rectilinear member is operable to generate an audible sound of least 75 decibels, particularly at least about 80 decibels, when the pressure roller is operated at below the threshold pressure. This embodiment produces sound that is sufficiently loud enough to carry over common background levels of building construction site noise. The rectilinear member may comprise an aluminum plate member having a thickness of about 0.5 to about 0.8 mm and having a rounded distal end. The rounded tip of the interference component of this embodiment reduces wear on the contacted gear. In another alternative embodiment, the pressure feedback system comprises an idler gear mechanism drivable in rotation by the drive train and including a reciprocally translatable interference component operable to interact with the idler gear to generate noise when pressure applied at the applicator roller is below a predetermined threshold pressure and to cease interaction with the idler gear and noise generation when the threshold pressure is met or exceeded. For example, the interference component comprises a flapper attached to the end of the extension arm operable to interfere with the teeth of an idler gear associated with a gear of the drive train that drives the take-up reel assembly. During tape dispensing using the device, the rotating idler gear teeth cause the flapper to vibrate or audibly clatter as it strikes a succession of teeth in rotation about the idler roll, generating an audible signal to the user that the user-applied application pressure is below the threshold value. For example, the tool may be used to alert the user if the user is not applying sufficient pressure to properly adhere the tape. In the event a user chose not to apply pressure adequate to disengage the interference component from the path of the gear teeth audible signal, all of the wear would occur and be restricted to the idler gear and would not occur on any working gears of the gear train. An idler gear configuration for this embodiment is not limiting, as comparable mechanisms also may be used therefor that can be mounted on the frame for rotary movement about a central axis and which have a plurality of radially extending fins or arms which can be driven in rotation by intermeshable gear teeth of an adjoining working gear of the drive means.

In these embodiments of the pressure feedback assembly, the interference component is reciprocally vertically translatable as a function of the magnitude of pressure applied to the applicator roller against the work surface. In a particular embodiment, the pressure feedback assembly has the audible signal mechanism mechanically associated with a fork rotatably mounted via a shaft to an applicator plate, which is rigidly mounted to the frame. A rod is provided for rotatably mounting the applicator roller to the fork. Torsion springs are arranged on the fork shaft, wherein the torsion springs are operable to normally bias the fork for pivotal movement in a first rotary direction. The extension arm is attached at one end to the fork for joint pivotal movement with the fork, and the other end portion of the extension arm includes the interference component operable to releasably contact gear teeth of an idler gear component or comparable mechanism when at rest and during rotation thereof when user-applied force to the applicator roller is below a predetermined threshold value, effective to generate an audible signal during rotation of the gear component. The fork is also rotatable in a second rotary direction opposite to said first rotary direction, wherein the feedback assembly is operable for pivoting the end portion of the extension arm away from the gear component to move the interference component out of contact with the gear teeth when user-applied force to the applicator roller at least equals the pre-determined threshold level, effective to discontinue the audible signal.

The stabilization brace prevents the pressure roller from bending relative to the transverse line of contact it makes on tape being fed to the pressure roller for application to an underlying surface, such that the entire width of the pressure roller can be maintained in constant contact with the tape at uniform pressure as the tape is applied, thereby reducing or preventing mistracking of the tape as it is being fed. The stabilization brace should be a rigid material construction. The shape of the stabilization brace is preferably swept downward along its main body between its opposite ends that are connected to applicator device so that access to the take-up reel assembly and other components of the applicator device are left unobstructed for access. During application of tape onto an inclined surface in particular using the tape applicator device, the tendency for uneven pressure to get applied across the width of the pressure roller may arise as the device is being manually manipulated by the user to accommodate the topography of the work surface such that torque forces become exerted on the pressure roller. This can lead to the pressure roller being torqued as one lateral side of the pressure roller is pushed harder towards the tape and underlying surface while the opposite lateral side thereof tends to lift away from the tape and underlying surface being taped for a short time period. This transient bending phenomenon, if not prevented, tends to lead to mistracking of the tape as it is being fed. Mistracked tape may not come into contact with the pressure roller and thus that portion of the tape is not sealed properly to the surface being seamed or otherwise taped with the device. In an alternative embodiment, to stabilize the applicator device against bending of the pressure roller due to torque forces, a transverse stabilization bracket can be included in the applicator roll assembly which is mounted to extend transversely between the inner face of the frame and the opposite lateral side of the applicator roller assembly.

In another embodiment, the applicator device further includes a static dissipative polymeric sheet member encircling the supply tape reel assembly and located between the supply tape/fed tape and the frame, wherein the polymeric sheet member has a resistivity effective to prevent discharge to/from proximate human contact. This static dissipative member acts as a shield to keep tape adhesive and grit from getting into the gears of the tape applicator while also dissipating static electricity that may build up due to the paper liner rubbing against the polymer shield member. In one embodiment, the polymeric sheet member comprises acrylonitrile-butadiene-styrene or other plastic surface-coated or filled throughout with an antistatic filler in amount effective to provide a resistivity of between about 10⁶ to about 10⁹ ohms per square. The antistatic filler may comprise non-carbon ally fillers used for this purpose or other suitable anti-static filling materials. The plastic shield can be stamped or cut from plastic sheeting containing a suitable static dissipative filler or coating.

In yet another embodiment, the applicator device further comprises a torque tool comprising a plurality of rigid posts extending from a grippable piece that is stowable within a recess provided in the supply roll reel assembly. The take-up reel assembly further comprises a spring nut including a plurality of holes in a pattern adapted to receive the plurality of posts of the torque tool, wherein the torque tool is manually insertable via its posts into the spring nut holes and the torque tool is operable to adjust the rotational tension of the take-up reel assembly via exertion of manual rotation force on the inserted torque tool. The torque tool can be used for adjusting the tension on the liner take-up reel assembly. For example, the liner tension provided by the take-up reel assembly tends to decrease over usage time, which can lead to sagging spent liner which may interfere with tape feeding. With the torque tool, the appropriate torque for the take-up reel can be set and checked as a quality control step in the assembly line and be readjusted easily over time by users in the field. The toque tool is tool carried aboard the applicator device that is readily available for use to tighten the tension on the take-up reel assembly in a facile and convenient manner.

In another embodiment, the applicator device further includes slip-resistant nubs integrally attached to and protruding from a side of the frame opposite the side upon which the take-up reel assembly and supply reel assembly are attached. The nubs have a closed end and an opposite open end, wherein the closed end comprises a generally flat surface from which a plurality of small integral projections extend to increase slip-resistance between the nubs and a contacted surface. The nubs may comprise composite structures including an elastomeric molding including the closed end, and the opposite open end holds a threaded nut, which allows the nubs to be removably fitted onto threaded bolt ends projecting through the frame. The nubs help to immobilize the applicator device in place if a user sets the device down on an inclined surface, such as a roof, as the nubs increase the slip-resistance of the device.

The adhesive tape applying devices embodied herein are operable to apply an adhesive tape material to a substrate surface, such as an adhesive tape material comprising an adhesive layer carried on a release liner, or alternatively a non-backed single-sided adhesive tape material. The hand grippable device is operable to dispense adhesive layers supplied from a relatively large diameter and heavy tape roll stored aboard the device onto uneven substrate surfaces. A roll of adhesive tape is mounted on and dispensed from the applicator device. The adhesive tape may be an adhesive tape material comprising an adhesive layer or film carried on at least one side of a releasable liner. The adhesive layer may be a single-side adhesive tape or double-sided adhesive tape. The device also may be used to apply non-lined single-sided adhesive tapes. The device is adapted to store, handle and apply relatively hefty spools of adhesive tapes. These adhesive tapes include, for example, a roll of adhesive tape material wound on a core part thereof which is mounted on the supply spool assembly, wherein the tape adhesive material has a width of 2 to 8 inches and has a diameter of 3 to 10 inches, and an initial roll weight of up to about 20 pounds, particularly from about 2 to about 10 pounds. The applicator device of embodiments herein can accommodate a relatively large diameter roll of adhesive tape, which reduces the frequency of tape roll changes needed. In a particular embodiment, the adhesive tape material comprises an adhesive layer comprising a moisture-resistant pressure-sensitive adhesive film carried on a face of a removable liner.

In one embodiment, the adhesive tape applying devices embodied herein are useful for relatively heavy-duty tape application applications such as building construction. For instance, the tape applicator devices such as those embodied herein are suitable for use in the construction of building structures, especially where it is desirable or useful to cover and seal gaps between abutting roofing panels, abutting wall panels, a window installation in a wall frame, a door installation in a wall frame, a plumbing vent installation in a roof, a skylight installation in a roof, a dormer in a roof, and so forth, with a moisture-resistant seam tape.

In one embodiment, there is a method of installing roofs using water-resistant panels arranged in an abutting configuration, wherein a tape applicator device is equipped with one or more features of embodiments of the present invention. The resulting applicator device is used to apply a water-resistant adhesive seam tape to cover and seal the gaps between the abutting panels, followed by attaching an outer roofing coverage (e.g., shingles, shakes, slate, and metal, etc.) without the need to include the typical prior step of applying felt paper. It also may be used for corner sealing. In another embodiment, there is a method of installing walls using water-resistant panels arranged in an abutting configuration, wherein a tape applicator device is equipped with a patterned pressure roller of embodiments of the present invention and is used to apply a water-resistant adhesive seam tape to cover and seal the gaps between the abutting panels, followed by completing the wall construction (e.g., adding siding, etc.) without the need to include the typical prior step of applying a water-proofing house wrap.

### BRIEF DESCRIPTION OF THE DRAWINGS

FIG. 1 is a perspective view of a device for applying adhesive tape to a building structure or other substrate according to an embodiment of the invention.

FIG. 2 is a perspective view of a pressure feedback assembly of the device of FIG. 1.

FIG. 3 is a side view of a pressure application assembly of the device of FIG. 1.

FIG. 4 is a perspective view of a portion of a pressure feedback assembly according to another embodiment comprising an audible feedback feature with the device of FIG. 1 in a resting position in which there is not an adequate user-applied force and audible feedback is generated.

FIG. 5 is a perspective view of a portion of a pressure feedback assembly of the device of FIG. 1 in a non-resting position in which there is adequate user-applied force and audible feedback is discontinued.

FIG. 6 is a schematical isolated side view of a gear train of the device of FIGS. 4-5.

FIG. 7 is an enlarged isolated side view of a portion of an alternative pressure feedback assembly to the arrangement of FIG. 6.

FIG. 8 is an enlarged isolated side view of the lower distal end of the interference component of pressure feedback assembly of FIG. 7.

FIG. 9 is an enlarged isolated side view indicating the flexure action of the interference component responsive to movement of take up spool assembly gear teeth against it in the alternative pressure feedback assembly of FIG. 7.

FIG. 10 is a perspective view of a portion of an alternative embodiment of the pressure feedback assembly comprising an audible feedback feature incorporated into an idler gear with the device of FIG. 1 in a resting position in which there is not an adequate user-applied force and audible feedback is generated.

FIG. 11 is a perspective view of a portion of a pressure feedback assembly of the device of FIG. 1 in a non-resting position in which there is adequate user-applied force and audible feedback is discontinued.

FIG. 12 is a schematical isolated side view of a gear train of the device of FIGS. 10-11.

FIG. 13 is a partial side elevation view of the device of FIG. 1 including a side brace and antistatic shield.

FIG. 14 is a partial side elevation view of the device of FIG. 1 including an alternative configuration of the side brace.

FIG. 15 is a front elevation view of the device of FIG. 1 including a lateral brace.

FIG. 16 is a side rear perspective view of the device of FIG. 13 including the lateral brace.

FIG. 17 is a bottom perspective view of the device of FIG. 1 including an alternative configuration of the device of FIG. 15 including a lateral brace.

FIG. 18 is an enlarged partial rear perspective view of the forward end portion of the device of FIG. 1 showing a cutting mechanism.

FIG. 19 is a side elevational view of device of FIG. 1 showing travel paths of an adhesive tape material and an adhesive layer and a liner thereof during tape dispensing.

FIG. 20 is an enlarged isolated perspective view of a take-up reel assembly of the device of FIG. 1 in a collapsed take-up reel configuration, in which the wedge is open to received the free end of the liner.

FIG. 21 is an enlarged isolated perspective view of the take-up reel assembly of FIG. 12 in an expanded configuration.

FIG. 22 is an exploded view of the take-up reel assembly of FIG. 20.

FIG. 23 is a bottom view of the take-up reel assembly of FIG. 20.

FIG. 24 is an enlarged isolated perspective view of an alternate take-up reel assembly of the device of FIG. 1.

FIG. 25 is an exploded view of the take-up reel assembly of FIG. 24.

FIG. 26 is an enlarged isolated perspective view of a tape spool assembly of the device of FIG. 1 with tape core-gripping cams in a collapsed, non-deployed configuration.

FIG. 27 is an enlarged isolated exploded view of a tape spool assembly of the device of FIG. 1 with tape core-gripping cams in an expanded, deployed configuration.

FIG. 28 is an enlarged view of a cam stop feature in region A in FIG. 27.

FIG. 29 is an enlarged isolated rear perspective view of a tape spool assembly of the device of FIG. 27 with tape core-gripping cams in an expanded, deployed configuration for holding a roll of tape via its core.

FIG. 30 is a side elevational view of the tape spool assembly of FIG. 29 with the cam handle removed for clarity.

FIG. 31 is a side elevational view of the tape spool assembly of FIG. 26 with the tape core-gripping cams in a collapsed, non-deployed configuration.

FIG. 32 is a side elevational view of the device of FIG. 1 with a roll of tape mounted on the supply spool assembly showing travel paths of an adhesive tape material and an adhesive layer and a liner thereof during tape application on a substrate surface.

FIG. 33 is an enlarged cross-sectional view of the tape supply spool assembly and take-up reel assembly of the device of FIG. 1 including respective clutch means incorporated therein.

FIG. 34 is a perspective view of a torque tool for the take-up reel assembly in another embodiment of the invention that is stowable aboard the device of FIG. 1.

FIG. 35 is a side elevational view of a spring nut of the take-up reel assembly modified to have a plurality of holes for simultaneously receiving plural posts of the torque. tool.

FIG. 36 is a perspective view of the supply tape reel assembly with the torque tool retrievably stowed in a recess thereof.

FIG. 37 is plan view of the torque tool.

FIG. 38 is an enlarged perspective view supply tape reel assembly with the torque tool retrievably stowed in a recess thereof.

FIG. 39 is a perspective view of the device of FIG. 1 showing the outer side of the frame including slip-resistant nubs.

FIG. 40 is an enlarged isolated view of a single nub illustrated on the device of FIG. 39 with a non-visible integral internally-threaded insert provided in one end thereof indicated by dashed lines.

FIG. 41 is an enlarged isolated top of a single nub illustrated on the device of FIG. 39.

FIG. 42 is a perspective view of a forward portion of a device having a patterned pressure roller for applying adhesive tape to a building structure or other substrate according to an embodiment of the invention.

FIGS. 43, 44, 45 and 46 are front elevational views of surface-patterned molded belt strips for use in patterned pressure rollers according to embodiments of the present invention.

FIG. 47 is a perspective view including a partial cut-way view of the outer roofing coverage to show an underlying assembly of roofing structural panels having a moisture-resistant seam tape applied to gaps at abutting side edges thereof which has been applied with a device according to FIG. 1.

FIG. 48 is a perspective view including a partial cut-way view of the outer wall coverage to show an assembly of wall structural panels behind thereof having a moisture-resistant seam tape applied to gaps at abutting side edges thereof which has been applied with a device according to FIG. 1.

The figures and elements therein are not necessarily drawn to scale. Similarly numbered elements in different figures represent like features unless indicated otherwise.

### DETAILED DESCRIPTION OF THE PREFERRED EMBODIMENTS

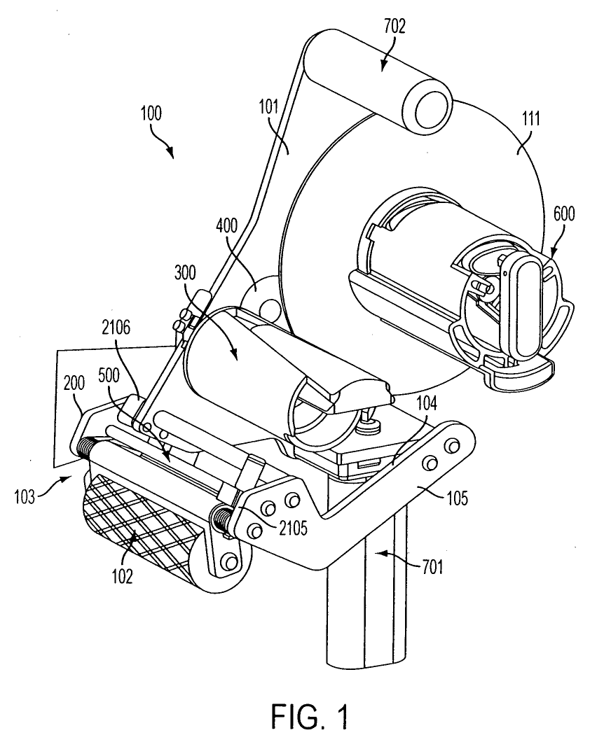

Preferred embodiments of the invention are described below by referring to the drawings. Referring to FIG. 1, a hand-grippable adhesive tape applicator device 100 is shown which is suitable for single- or dual-handed operation in building construction and other environments. The device 100 includes a frame 101; an applicator roller assembly 103 including applicator roller 102; and a pressure feedback assembly 200, release liner take-up reel assembly 300; a gear train 400; tape cutter 500, a tape supply spool assembly 600, side brace 105, and a static dissipative shield 111.

A second hand grip 702 is mountable at a top portion of the frame 101 generally opposite to the first grip 701. The first grip 701 comprises a first grip body oriented generally perpendicularly to a rotational axis of the tape spool assembly 600, while the second grip 702 comprises a second grip body oriented generally parallel to the rotational axis of the tape spool assembly 600. The first grip is positioned in-line with the applicator roller so that the device user/operator may apply significant force to the applicator roller without generating a radial-ulnar moment about the user's wrist. By this arrangement, the center of gravity of the device with a mounted tape roll is provided over the center of an operator's wrist. The handle 701 also may be provided with standard grip ribbing (not shown) to increase non-slip grippability for ease of operation under damp conditions. For instance, the handle 701 may be constructed as a hard plastic base having a thin layer of ribbed elastomeric coverage. The handle or hand grip 701 of tape applicator device 100 alternatively may be a pistol-style handle having a profile which varies along its length to accommodate to the palm of the user. The central portion of the handle should fit into the hollow of the user's palm. The handle may be more bulbous in the central portion of the handle.

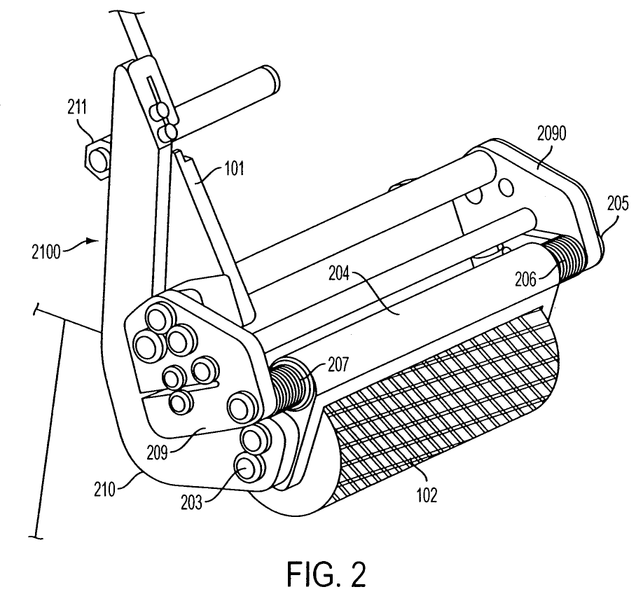

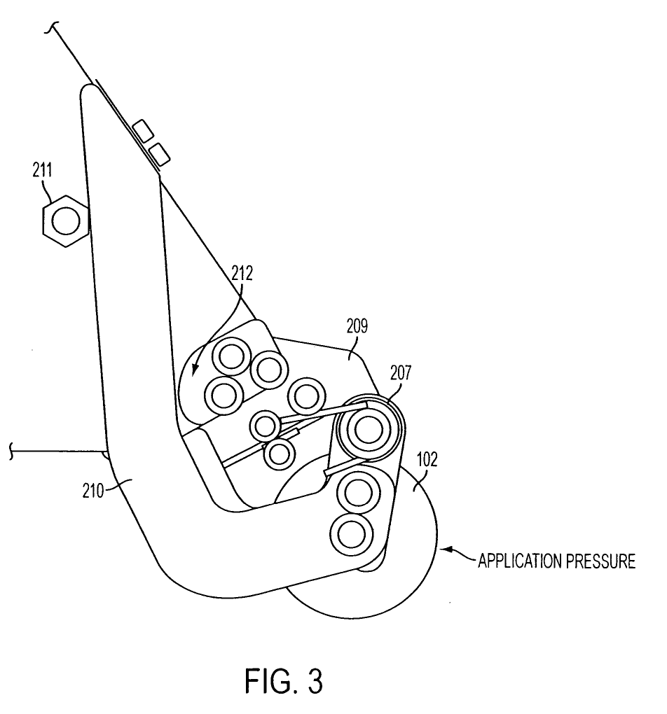

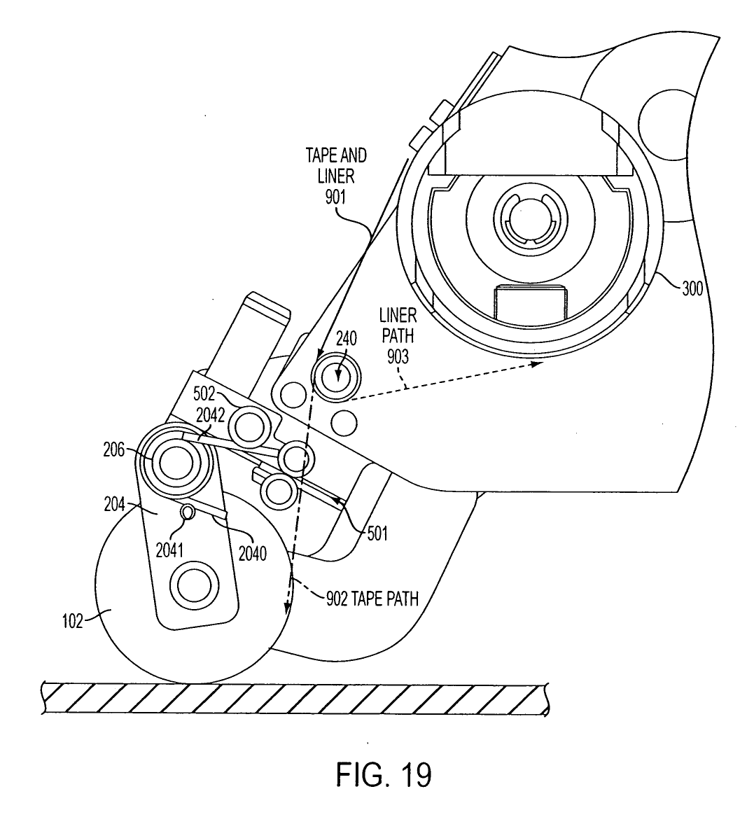

The handheld pressure-sensitive adhesive tape applicator 100 provides means of providing feedback to the operator about the amount of pressure being applied. FIG. 2 depicts a pressure feedback assembly 2100 with several parts unrelated to the pressure feedback assembly having been removed for clarity. The pressure roller 102 rotates on an axle (not visible) mounted in the fork 204. The fork 204 itself rotates about its own axle 205. Torsion springs 206 and 207 bias the fork 204 clockwise about this axle 205 (from the exposed-side perspective of frame 101 shown in FIG. 1, and counterclockwise in the rear-side perspective of FIG. 3). Axle 205 extends between a first applicator plate 209 mounted to frame 101 and a laterally opposite second applicator plate 2090. An extension arm 210, which is rigidly attached to the fork 204, stops against the take-up reel assembly nut 211 to limit the rotation of the pressure fork 204. FIG. 2 shows an enlarged view of the extension arm 210 in the resting position. Again, the torsion springs 206 and 207 bias the fork 204 and arm 210 counterclockwise, but the arm 204 stops against the take-up reel assembly nut 211. The springs 206 and 207 are preloaded such that the fork 204 will not rotate in the clockwise direction until the application pressure reaches a pre-determined threshold level. The effort or work required to seat the tape is supplied by the user as a force against the surface to which the tape is applied and becomes the application pressure needed to seat that tape at the pressure roller. The amount of pressure required to seat the tape will depend on the circumferential contact area of the pressure roller and the tape as well. In one non-limiting embodiment, this application pressure is about 1 pounds to about 10 pounds user-applied force, particularly about 2 pounds to about 6 pounds user-applied force. As best seen in FIG. 19, spring 206 includes a first spring stem 2040 which bears against a post 2041 provided on fork 204, and a second spring stem 2042 at the opposite axial end of the same spring 206, which bears against a cutter slide guide 502. Spring 207 has a similar loaded configuration (e.g., see FIG. 3). At this point the fork 204 rotates clockwise several degrees until the front side of the extension arm 210 hits the forward stop 212 (see FIG. 3). Thus the pressure feedback assembly 200 has two positions: a resting position, when the application force is below the threshold value, and a working position, when the threshold pressure is met or exceeded. This fact may be exploited to provide feedback to the user about the pressure level or user-applied force. A suitable amount of spring load to provide the above-mentioned functionalities can be empirically determined in the selection of springs 206 and 207.

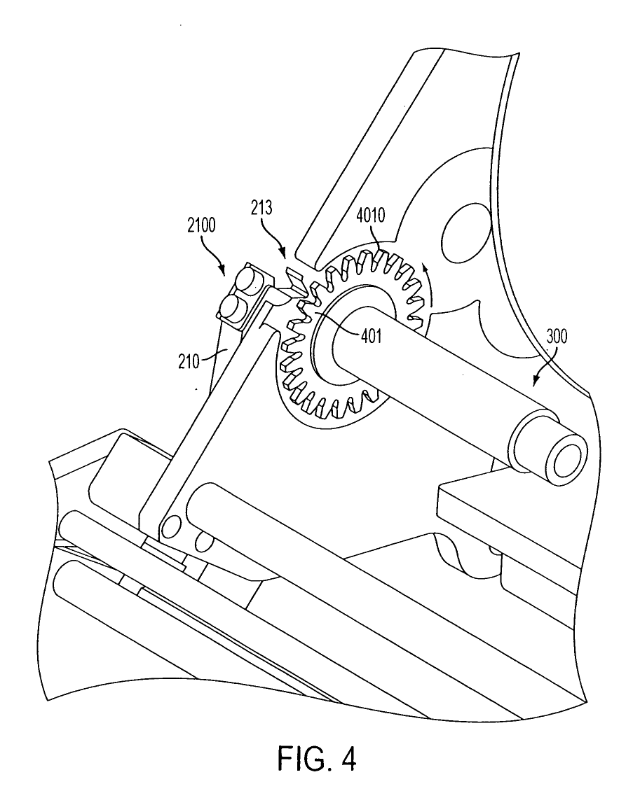

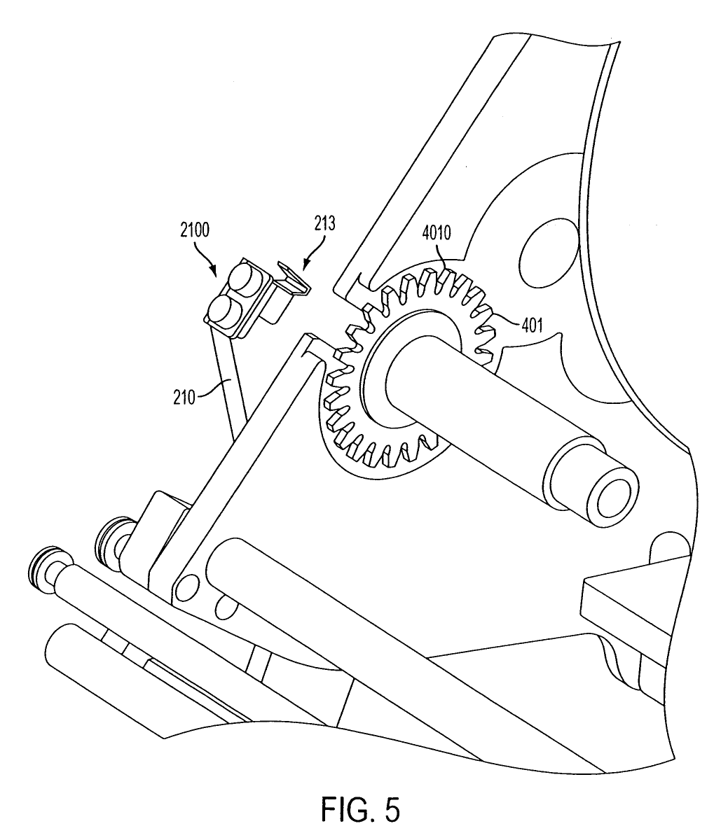

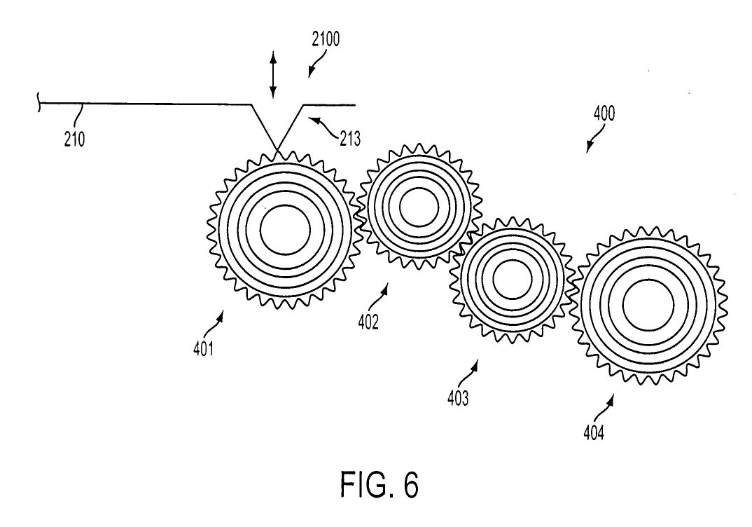

One way to provide audible feedback with a pressure feedback assembly 2100 is illustrated in FIGS. 4-6. In this particular embodiment, the interference component 213 of the feedback assembly 2100 lays to the left (in the perspective of the provided view) of the gear 401 responsible for driving the liner take-up reel assembly 300. This configuration allows for an increased build up of potential energy in the interference component 213. Upon release, the increased vibration of the noise-maker increases the sound volume that is created. In this illustration, the interference component 213 comprises a sheet metal flapper attached to the end of the extension arm 210 such that it interferes with the teeth 4010 of the take-up reel assembly gear 401 when the arm 210 is in the resting position. As illustrated in FIG. 6, gear 401 forms part of gear train 400 (also including gears 402, 403, and 404 in this illustration) included in device 100 which is described in more detail below. The extension arm 210 and flapper 213 are operable to reciprocally move in a vertical direction relative to the axially-stationary rotatable gear 401, as indicated in FIGS. 4-6, subject to the amount of pressure force applied at the applicator roller. If tape is dispensed in this position, the rotating gear teeth 4010 cause the flapper 213 to vibrate, generating an audible signal to the user that the application pressure is below the preselected desired threshold value. An optional amplifier (not shown) may be added to increase the volume of the audible signal. If the user increases the application pressure to suitable levels, the pressure fork 204 and arm 210 will rotate to the active position, shown in FIG. 5, lifting the flapper 213 out of the gear teeth 4010 and ending the audible signal during the application of tape and providing the user with a signal that the tape is being applied with adequate pressure.

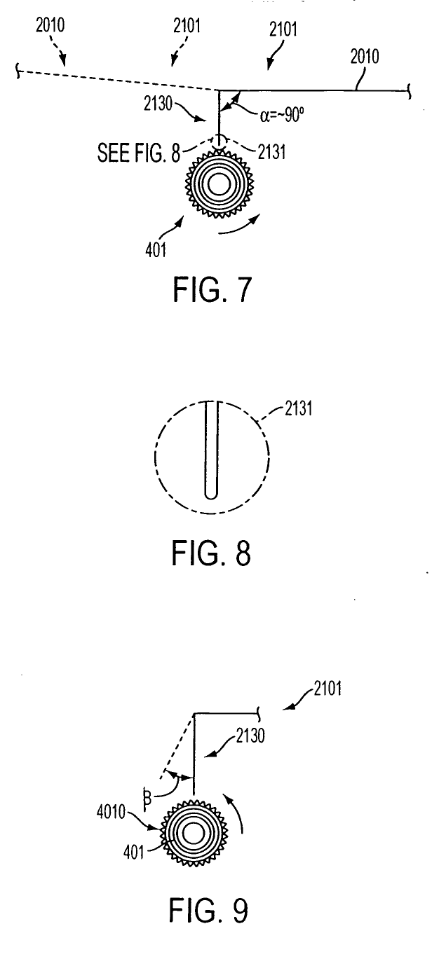

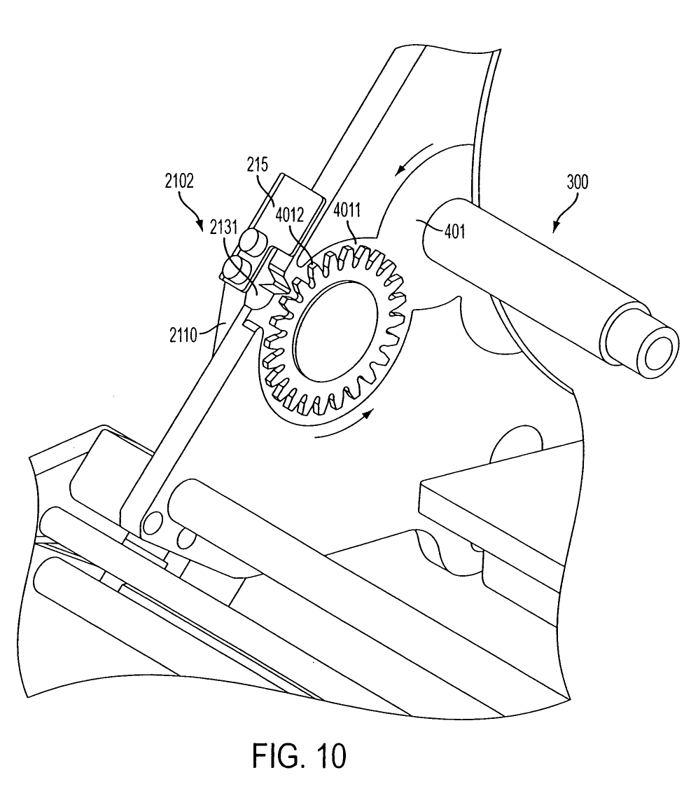

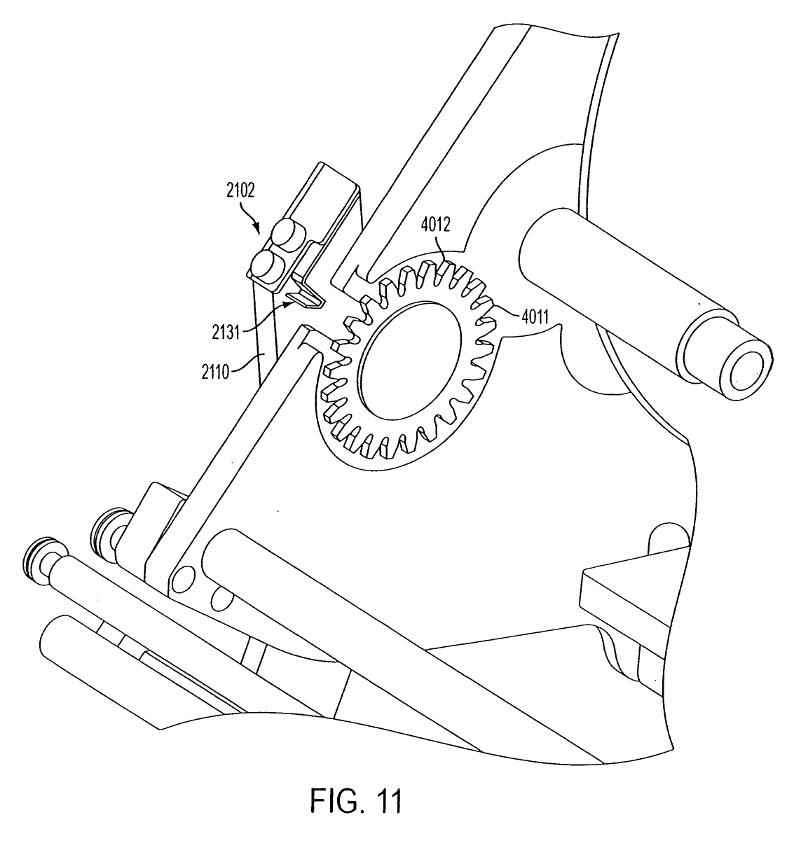

Referring to FIGS. 7-9, in another embodiment an audible feedback assembly 2101 is provided in which the interference component 2130 comprises a rectilinear member having a rounded distal tip 2131 wherein the rectilinear member 2130 extends from an extension arm 2010 at an approximately 90 degree angle (α) relative to the recesses between adjacent gear teeth of the take-up reel assembly gear 401. The extension arm 2010 can extend from the right-side (i.e., the tape roll side), or the left-side (i.e., the pressure roller side) as indicated in dashed lines, from gear 401. Schemes for arranging the extension arm 2010 to the right-side of gear 401 are illustrated in FIGS. 10-11, while the left-side arrangement is illustrated in the embodiment of FIGS. 4-6. The rectilinear member 2130 is operable to generate an audible sound of least 75 decibels, particularly at least about 80 decibels, when the pressure roller 102 is operated at below the threshold pressure. This embodiment produces sound that is sufficiently loud enough to carry over common background levels of building construction site noise. The rectilinear member 2130 may comprise an aluminum plate member having a thickness of about 0.5 to about 0.8 mm and having a rounded distal end. The rounded tip 2131, illustrated in FIG. 8, may be provided, e.g., by machining (e.g. honing) an end of the member or mechanically curling the end portion. The rectilinear piece 2130 is a construction that can flex but not permanently bend upon interacting with the gear teeth. The rounded tip 2131 of the interference component of this embodiment reduces wear on the contacted gear. Referring to FIG. 9, the rectilinear piece 2130 may be aluminum construction in a thickness that is stiff yet flexible so as not to offer too much resistance, but also not too thin to get permanently bent. The metal rectilinear interference component 2130 is operable to resiliently flex and spring back through an angle β when contacting and clearing individual gear teeth as the gear rotates. By comparison, the v-shaped flapper 213 illustrated in the feedback assembly 2100 illustrated in FIGS. 4-6 projects into the gear 401 at an angle of approximately 80 degrees, and may have a thickness, e.g., of about 0.4 to about 0.45 mm (aluminum).

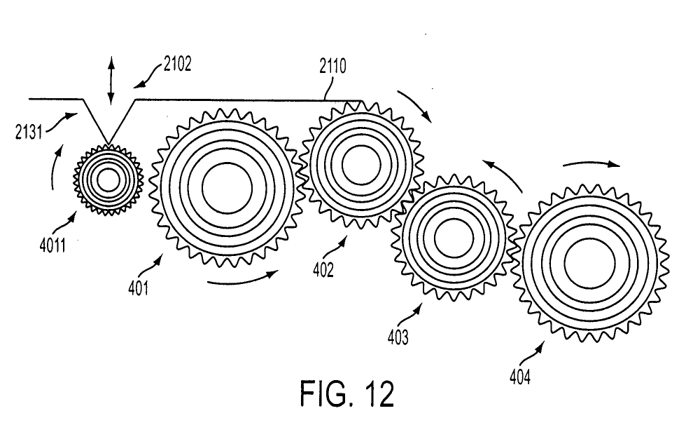

Referring to FIGS. 10-12, in an alternative embodiment for providing pressure feedback, a pressure feedback assembly 2102 comprises an idler gear 4011 drivable in rotation by the above-mentioned drive train 400 and including a reciprocally translatable interference component 2131 operable to interact with the idler gear 4011 to generate noise when pressure applied at the applicator roller 102 is below a predetermined threshold pressure and to cease interaction with the idler gear 4011 and noise generation when the threshold pressure is met or exceeded. For example, the interference component comprises a flapper similar to feature 213 attached to the end of an extension arm 2110 operable to interfere with the teeth 4012 of the idler gear 4011 associated with gear 401 of the drive train 400 that drives the take-up reel assembly 300. Referring to FIG. 4, during tape dispensing using the device 100 at a pressure force below the predetermined threshold pressure for the applicator roller 102, the rotating succession of idler gear teeth 4012 of idler gear 4011 causes the flapper 2131 to vibrate or audibly clatter as it strikes a sequence of the teeth 4012 in rotation about the idler gear 4011, generating an audible signal to the user that the user-applied application pressure is below the threshold value. The pressure feedback assembly 2102 alerts the user if the user is not applying sufficient pressure to properly adhere the tape. Referring to FIG. 5, once sufficient pressure is applied at applicator roll 102 to meet or exceed the predetermined threshold pressure, the extension arm 2110 will raise the flapper 2131 a sufficient distance to clear gear teeth 4012 of idler gear 4011 and discontinue the audible clatter signaling. In the event a user chose not to apply pressure adequate to disengage the interference component 2131 from the path of the gear teeth 4012 and ignore the audible signaling of the feedback assembly 2102, all of the wear that would occur would restricted to the idler gear 4011 and would not occur on any working gears (401, etc.) of the gear train 400 (see FIG. 6). The tape dispenser 100 thereby can still function properly and efficiently after wear occurs at the idler gear teeth 4012, as the gear train 400 remains intact. An idler gear configuration for this embodiment is not limiting, as comparable mechanisms also may be used therefor that can be mounted on the frame for rotary movement about a central axis and which have a plurality of radially extending fins or arms which can be driven in rotation by intermeshable gear teeth of an adjoining working gear of the drive means.

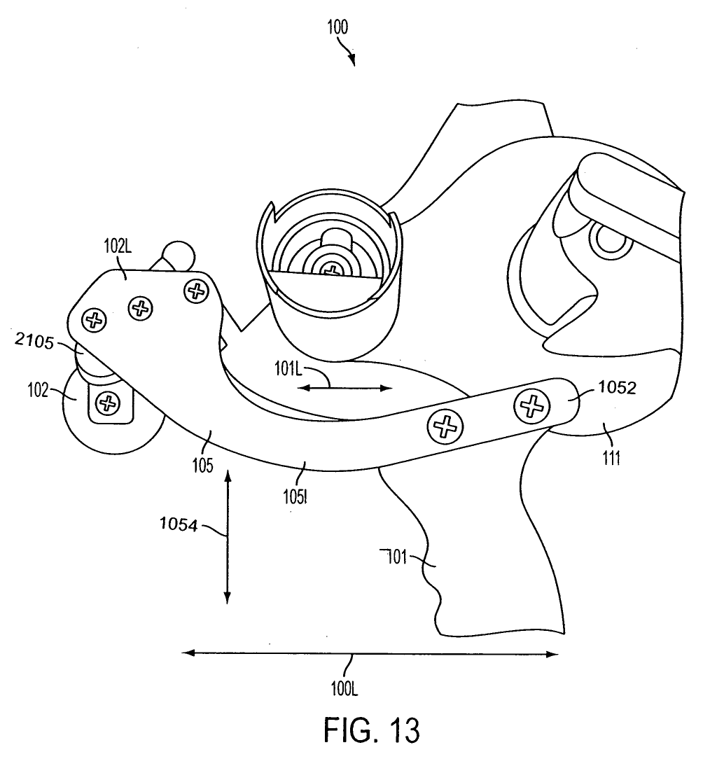

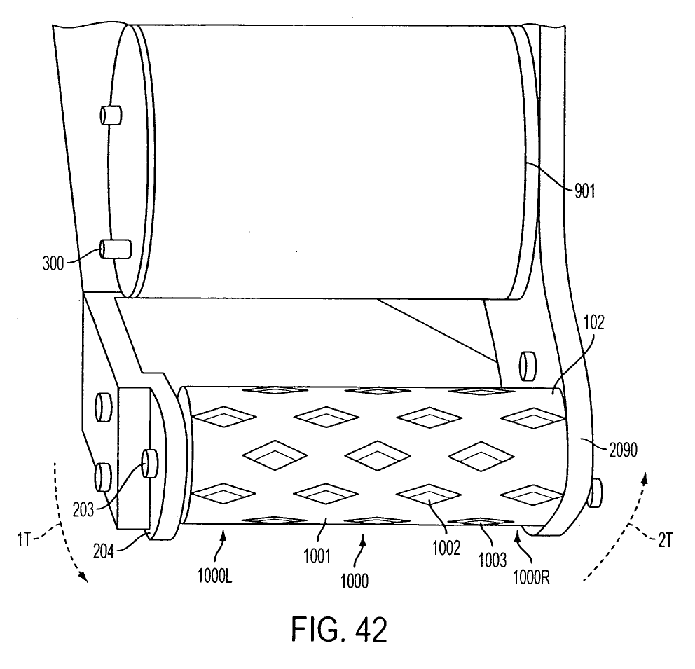

Referring to FIG. 13, a stabilization brace 105 prevents the pressure roller 102 from bending relative to the transverse line of contact it makes on tape being fed to the pressure roller 102 for application to an underlying surface, such that the entire width of the pressure roller 102 can be maintained in constant contact with the tape at uniform pressure as the tape is applied, thereby reducing or preventing mistracking of the tape as it is being fed. The brace or bracket 105 should have a stiff rigid construction that resists out of plane flexure or bending. It may be metal plate, ceramic plate, composite plate, and so forth. It can be bolted, screwed, soldered, and/or bonded in place on device 100 in the locations described herein in any convenient manner. The shape of the stabilization brace is preferably swept downward (i.e., the direction 1054 of the first hand grip 701) along its main body 1051 between its opposite ends 1052, 1053 that are connected to device 100, as illustrated in FIGS. 1 and 13, so that access to the take-up reel assembly and other components of the device 100 are left unobstructed for access. Referring to FIGS. 1 and 13, the stabilization brace 105 extends in a direction 100L generally parallel to and laterally spaced from said longitudinal direction 101L of the frame 101 connecting (a) a first lateral side 2105 of the applicator roller assembly 103 located opposite the second lateral side 2106 thereof located nearest the frame to (b) the base portion 104 of the frame 101, effective to reduce bending of the applicator roller during tape application. When applying tape on a sloped surface, such as a roof, there is an increased tendency for the pressure roller 102 to torque such that a portion of the pressure roller 102 laterally spaced from the support frame 101 tends to lift out of contact with the tape as it is being applied to a receiving surface and the entire width of the pressure roller 102 does not stay in contact therewith. For example, and cross-referencing FIG. 42 in which pressure roller 102 and 1000 are referenced interchangeably here, the torque forces that the stabilization brace 105 prevents from developing in the applicator roller 1000 (102) are a downward force 1T on the frame side of pressure roller 1000 (i.e., the left side 1000L of the pressure roller 1000 as oriented in FIG. 42) and an upward force 2T on the opposite side of the pressure roller (i.e., the right side 1000R of pressure roller 1000 as oriented in FIG. 42). This causes the tape application head to bend in the directions of the indicated torque forces. That is, the right side of the tape head would lift upwards and away from the surface being taped while the left side of the tape head would be compressed against the surface being taped with added force. The head will not necessarily always lift up. Often, full contact across the pressure roller can be maintained, but the body 101, where assembly 200 connects to 101 would permanently bend, causing the tape to mistrack. These torque forces, if not prevented by the stabilization brace, would cause the tape to mistrack as it is being fed. The amount of mistracking can vary depending on variables such as the amount of torque, type of tape, etc., but can approach or even exceed significant amounts such as 0.25 inch of the tape. Thus, if the brace 105 is not used, a portion of mistracked tape may not come in contact with the pressure roller and as a consequence the tape may not be sealed properly across its entire width.

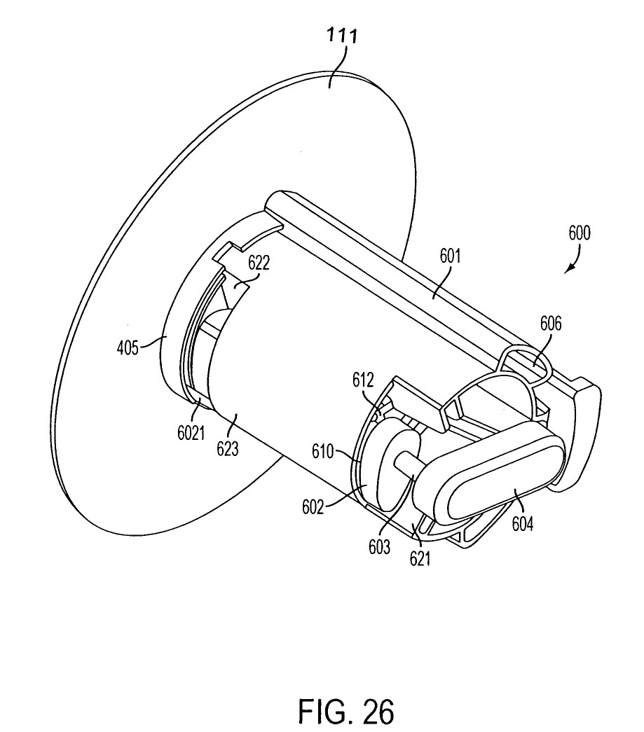

Referring still to FIG. 13 (and also FIGS. 26, 27, and 33), the applicator device 100 further includes a static dissipative polymeric sheet member 111 encircling the supply tape reel assembly 600 and located between the supply tape/fed tape and the frame 101, wherein the polymeric sheet member 111 has a resistivity effective to prevent discharge to/from proximate human contact. This static dissipative member 111 acts as a shield to keep tape adhesive and grit from getting into the gears of the tape applicator while also dissipating static electricity that may build up due to the paper liner rubbing against the polymer shield member. In one embodiment, the polymeric sheet member comprises acrylonitrile-butadiene-styrene or other plastic surface-coated or filled throughout with an antistatic filler in amount effective to provide a resistivity of between about 10⁶ to about 10⁹ ohms per square. The antistatic filler may comprise non-carbon alloy fillers used for this purpose or other suitable anti-static filling materials. The plastic shield 111 can be stamped or cut from plastic sheeting containing a suitable static dissipative filler or coating. The static dissipative shield 111 may be a circular-shaped sheet member, or have another geometric shape, with a central or interior hole provided that is large enough to accommodate the profile of the tape supply spool assembly 600 so as not to interfere with its rotary movement. Although not limited thereto, the plastic shield 111 may have a thickness generally from about 1.0 to about 1.5 mm.

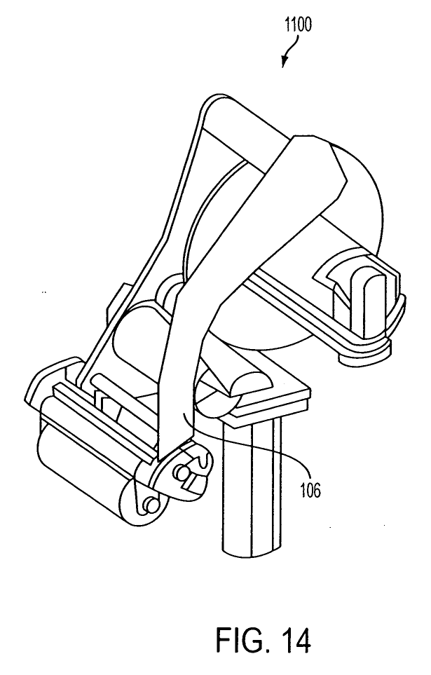

FIG. 14 illustrates an alternate configuration of a side brace 106 on a tape applicator device 1100, which is otherwise similar to device 100 as described herein.

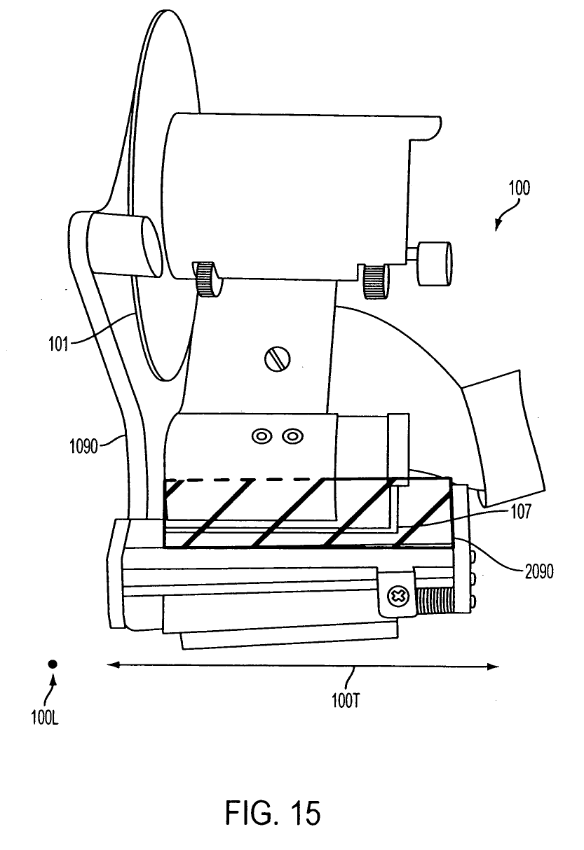

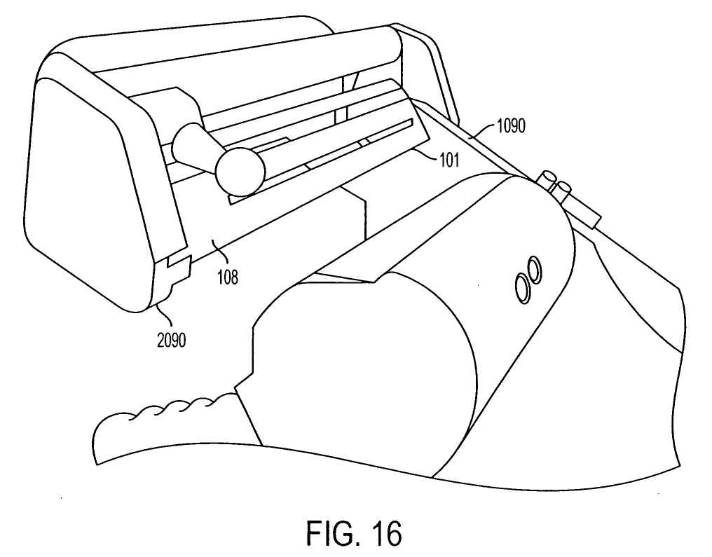

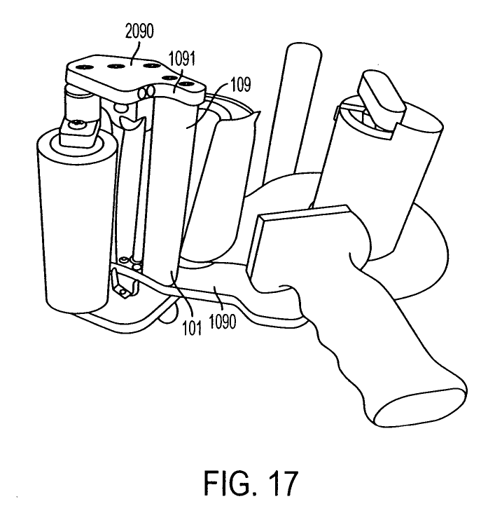

Referring to FIGS. 15-17, as an alternative to stabilization brace 105 discussed above in connection with FIG. 13, stabilization also can be provided to help prevent the above-mentioned head bending and tape mistracking problem by the inclusion of a transverse stabilization bracket(s) in the applicator roll assembly 103 of device 100. As illustrated in FIGS. 15-16, this bracket may be a thick rectangular bar 107 or 108 constructed of rigid material (e.g., metal) mounted between an inside surface 1090 of the frame 101 and a roller assembly side plate 2090 of the applicator roll assembly 103 located at the opposite lateral side thereof, such that the bar 107 or 108 extends parallel to the transverse direction 100T of the device 100. Referring to FIG. 17, in an alternative embodiment, the transverse bar 109 is fixedly mounted between inner frame surface 1090 and a finger-like extension 1091 provided for roller assembly side plate 2090.

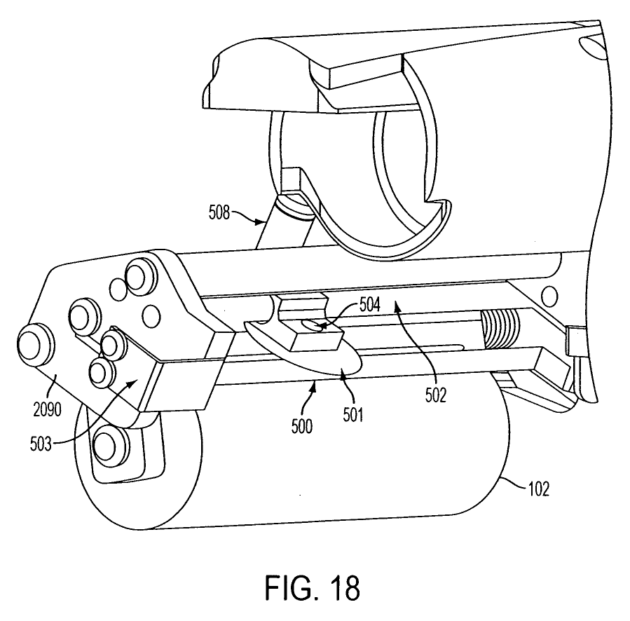

Referring to FIG. 18, an integrated sliding cutting mechanism 500 is provided allowing tape to be cut before it is routed around the applicator roller 102. A rotary cutting blade 501 is operable to slide back and forth on a cylindrical guide 502. A cutting blade handle 508 is provided for allowing a user to manually move the blade 501. A blade guard 503 is provided to impede contact with the blade when it is stored axially to the side of the tape routing area. The blade guard 503 also interacts with the blade bolt 504 to create detent positions at the two lateral extremes of the travel of blade 501, outboard of the tape width. In this manner, the blade 501 may be stowed and held in place, away from the tape, until the user slides it across the tape to make the cut, providing a dispensed tape of desired length. The blade guard also holds up the blade, keeping it from rotating downward until it is perpendicular with the working surface. A significant benefit of the sliding rotary cutter 501 is that it cuts the tape neatly, leaving the two cut ends unwrinkled. Unwrinkled tape produces a higher quality taped joint. It is important to prevent wrinkles when the tape is used as a sealing means against liquids; the wrinkles can be a source of leaks.

Referring to FIG. 19, an illustration is provided how the unlined tape 902 is routed past the blade 501. Lined tape 901 comes around the liner take-up reel assembly 300 is routed around a pulley 240, and then to the pressure roller 102. The pulley 240, or pin, ensures that the tape is consistently presented to the cutting mechanism 500 regardless of the wound diameter of the take-up reel assembly 300. The pulley 240 also ensures that the liner 903 consistently releases from the tape material 901 at the pulley 240 and heads toward the take-up reel assembly 300. Consistent release before the blade 501 ensures that the release liner 903 will not be cut along with the tape 902. If the user keeps tension in the tape, the segment of tape between the pulley 240 and the pressure roller 102 is held taut against the blade 501 as the user slides the blade 501 across the unlined tape 902.

The pressure feedback informs and encourages the user to apply appropriate pressure, while the integrated sliding cutting mechanism minimizes wrinkling of the ends of the tape. The tape applicator of embodiments of the present invention can produce higher quality taped joints than traditional tape applicators. As indicated, the tape applicator of embodiments of the present invention may use a sliding cutter to minimize wrinkling and improve adhesion. A particular benefit of cutting the unlined tape 902 before it reaches the pressure roller 102 is that, after cutting, the pressure roller may be used like a stand-alone roller to re-pressurize any under-pressurized sections of tape. When the user wishes to resume dispensing tape, the user reaches between the cutting mechanism and the liner take-up reel assembly to grab the loose end of tape and pull it out and around the pressure roller. This cannot be done with some traditional tape applicators because the loose end of the tape gets in the way. Some traditional tape applicators use a serrated blade mounted after the pressure roller to cut the tape. The twisting motion necessary to make the cut often induces wrinkles in the cut ends of the tape which can compromise the quality of the taped joint. Traditional serrated blades also present more of a safety hazard because the design exposes the blade in a more accessible configuration and because these blades are often unguarded. Although these embodiments include a release liner take-up system, alternative embodiments are also contemplated within embodiments of the present invention for handling un-lined tape material. The invention may be adapted for applying any type of pressure-sensitive adhesive tape.

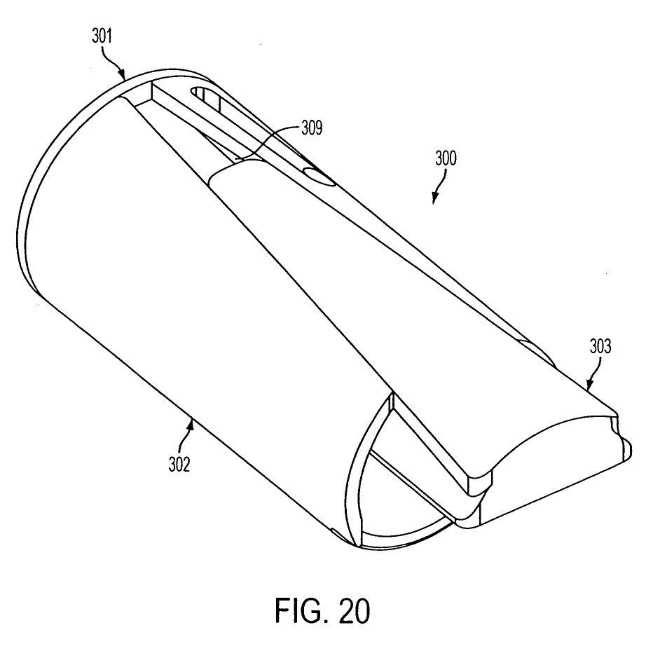

Referring to FIG. 20, an expandable/collapsible take-up reel assembly 300 is provided for storing tape liner, film, or other flexible web material (e.g., see FIG. 19, liner 903). A loose end of the web material is affixed to the reel assembly 300 in an expanded position thereof and the reel rotated to collect the liner material. The reel assembly 300 is self-locking such that it does not collapse under the pressure of the wound liner material 903. When the user wishes to remove the wound-up material from the reel assembly 300, the user may collapse the reel assembly 300 to a smaller diameter so that the wound roll of material may be easily slid axially off of the reel assembly 300 in one piece.

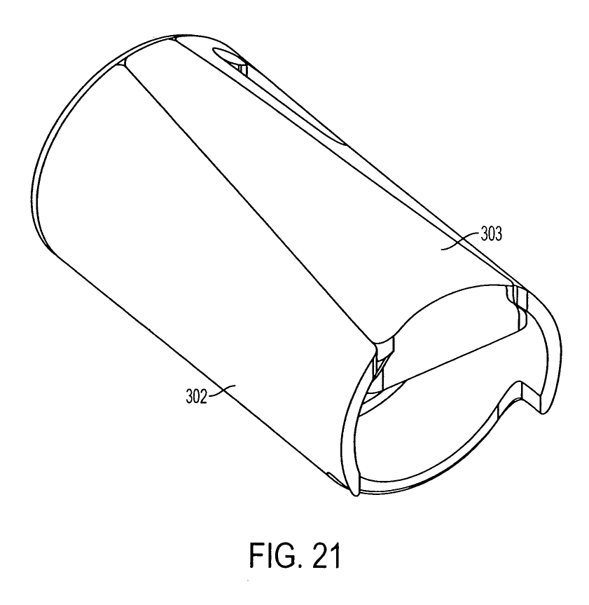

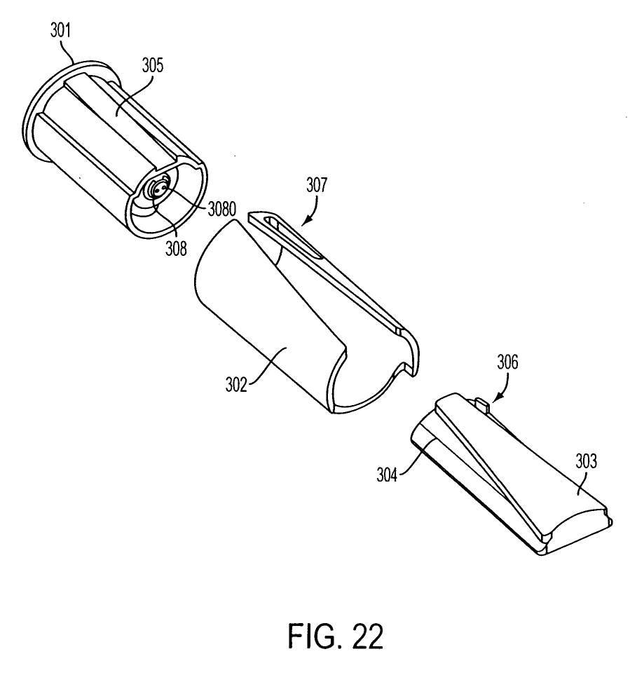

Referring more particularly to FIG. 20, the take-up reel assembly 300 includes a reel base 301, a C-shaped shell 302, and a wedge element 303. The reel assembly 300 is shown in the collapsed position. When the wedge element 303 is pushed axially into a wedge-shaped opening 309 in the shell 302, the shell 302 expands to a larger diameter, shown in FIG. 21. Referring to FIG. 22, the wedge element 303 rides on a ramp 305 on the reel base 301, such that it travels radially away from the reel center as it moves axially from the collapsed to the expanded (wedge out) position. Thus the diameter of the reel assembly 300 increases/decreases as the wedge element 303 is moved into/out of the wedge opening on the shell 302. Friction on the shallow wedge and ramp surfaces prevents the wedge from moving under the compressive force of the wound material. Still referring to FIG. 22, flanges 304 on the wedge element 303 ride between the shell 302 and the base 301, holding the wedge element 303 against the aforementioned ramp 305 on the base 301. A tab 306 on the wedge element 303 rides in slot 307 in the shell 302, limiting travel of the wedge element 303 to a working range and preventing it from falling off the assembly 300. The reel assembly 300 rotates on an axle 308.

Referring to FIG. 23, flathead screws 309 or other functionally similar attachment means on the opposite side of the reel assembly 300 hold the shell 302 to the base 301. A vertical wall 310 is provided on the inner side of the wedge element for the user to grip when moving the wedge element from the expanded to the collapsed position and vice versa. An opening 311 on the shell 302 allows a user's finger(s) access to the wall 310 and a place to grip the wound-up material 903 during removal.

To use the collapsing take-up reel assembly, the user first pulls the wedge element to the expanded position then threads the loose end of the material to be wound into the gap between the wedge and the shell. Next the user pushes the wedge element into the wedge-shaped opening on the shell, expanding the reel diameter and trapping the material end between the wedge element and the shell. The contractive tendency of the shell pinches the material end in place, holding it against significant tension during the first two wraps of winding. After two wraps the wrap friction itself can withstand the wrap tension. When the user wishes to remove the material from the reel 300, the user places his/her fingers behind the vertical wall 310 and pulls the wedge element 303 to the collapsed position. The reel diameter decreases, and the shell relaxes its pinch on the start end of the material. The user can grab the wound material at the shell opening 311 and easily slide it axially off the collapsed reel.

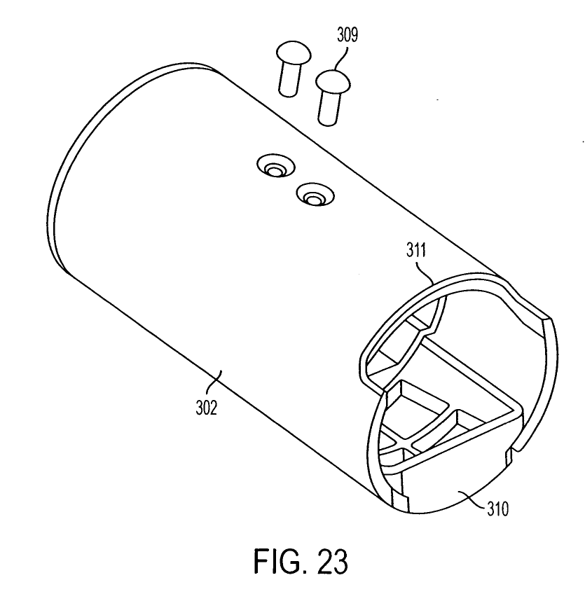

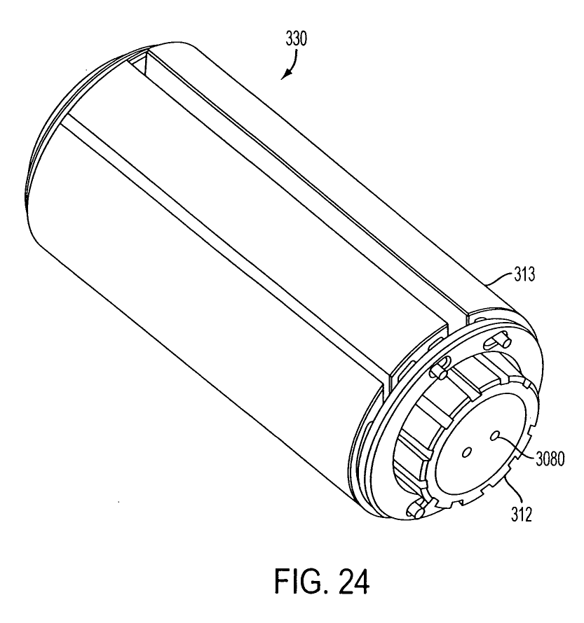

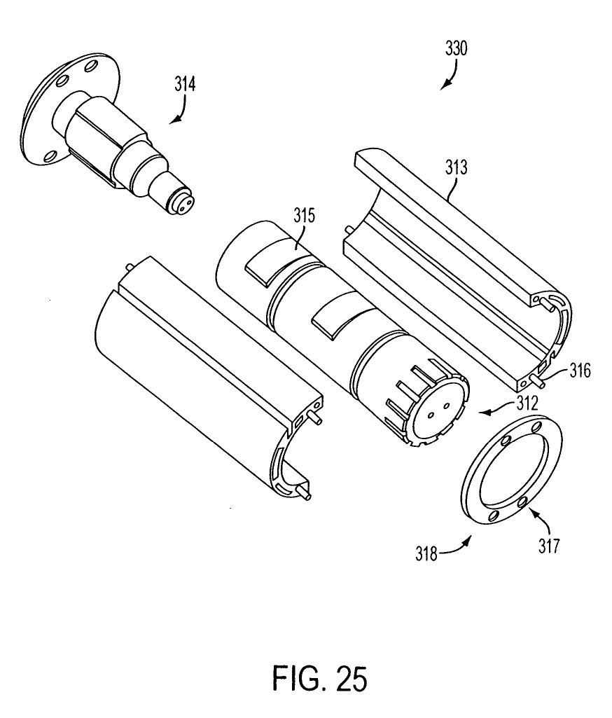

An alternate embodiment of the take-up reel assembly is depicted in FIG. 24. The take-up reel assembly 330 of this embodiment comprises a central cam member 312 and two translating shell halves 313. Rotation of the cam member 312 causes the translating shell halves 313 to move away from each other, thereby expanding the diameter of the reel assembly 330. Referring to FIG. 25, cam member 312 rotates on reel base 314. Features on the reel base 314 limit the rotation to 90 degrees. Cam ramps 315 on the cam member 312 ride against the inner surfaces of the shell halves 313, pushing them away from each other when the cam member 312 is rotated clockwise. Pins 316 on the shell halves 313 travel in slots 317 on the reel base 314 and the reel cap 318, constraining the shell halves to translational motion. A detent feature on the insides of the shell halves 313 locks them in place against the collapsing pressure of the wound material. Rotating the cam member 312 counterclockwise allows the shell halves 313 to collapse towards each other. To use the reel assembly 330, the user first turns the cam member 312 clockwise to expand the reel diameter. The loose end of the tape liner material is placed against the shell and the reel turned 2-3 times such that wrap friction anchors the material to the reel 330. The reel 330 may then be rotated to collect the material. When the user wishes to remove the material from the reel 330, he rotates the cam member 312 counterclockwise. Pressure from the tightly wound material collapses the shell halves 313, allowing the user to grab the wound material and slide it axially off the collapsed reel 330.

The collapsing take-up reel assembly 300 (330) may be utilized on any device that stores tape liner, film, or other flexible web material. It is easier, faster, and tidier for a user to reload (removing previously wound material and starting a new length of material) than a standard non-collapsing reel. Further, the reduction of the required installation/removal force provided is convenient when the user is standing on a ladder or a steeply pitched roof, etc. Prior tape applicator devices include non-collapsing liner take-up reels as used on construction tape guns, etc. That prior technology works adequately during use but can be very difficult to load and unload. Loading is typically performed by threading the end of the liner into a tight gap on the reel, which can be difficult and time-consuming. When it comes time to unload, the liner may be tightly wound on the reel, preventing the user from sliding it off axially. The user must either unwind the liner from the reel or cut it off. Either technique is time-consuming and produces a significant mess. The collapsing nature of the disclosed take-up reel assembly of embodiments of the present invention allows the user to quickly and easily slide the wound-up liner axially off the reel. The entire roll may be removed at once, and the neatly wound roll is easier to store, transport, and dispose of than is a loose tangle of un-wound liner or a bunch of loose small pieces. Loading is also improved as the liner end is threaded into a large gap then pinched in place (preferred embodiment) or simply wound up on the reel (alternate embodiment).

Referring to FIGS. 26-31, an expansible/collapsible spool assembly 600 also is provided for storing and/or dispensing tape, rope, film, or other flexible material that is wound around a tubular core. A roll of material 900 comprising tape 901 wound on a rigid tubular core 907 is loaded onto the spool assembly 600 while it is in the collapsed position, then the spool assembly 600 is expanded to interfere with the inner diameter of the tubular core 907. This interference generates friction, which holds the roll 900 to the spool assembly 600 in both the axial and rotational directions. The rotational friction is important if gears are attached to this spool assembly 600 that drive other elements, for instance, another that collects a spent release liner from a tape, film, etc. The rotational coupling between roll 900 and spool assembly 600 enables the unwinding action of the material to drive the spool 900 about its axis and transmit power to some other device, such as a tape liner take-up reel assembly 300. When the wound material is exhausted, the spool assembly 600 may be collapsed and the spent core 907 removed.

Referring more particularly to FIG. 26, a spool body 601 and one or more eccentric cams 602, 6021 mounted to a common camshaft 603 that rotates with respect to the spool body 601. A handle 604 attached to the camshaft 603 is provided as a means to turn the camshaft 603, and toggle the spool assembly 600 from the expanded to the collapsed position (shown in FIG. 26), and vice versa. Stops 610 and 612 on the cam(s) 602, 6021 and spool body 601, respectively, limit the rotation of the camshaft to approximately 100 degrees clockwise from the shown position.

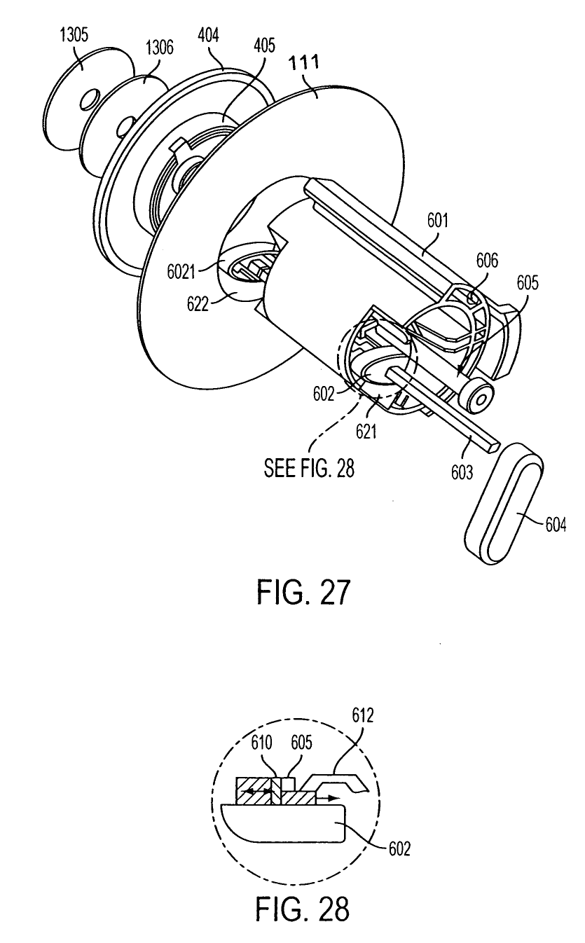

Referring to FIG. 27, the entire spool assembly 600 rotates on the shoulder of the shoulder screw 605 also referred to herein as central spool shaft that holds the spool assembly 600 to the tape applicator or other device 100. The spool body 601 includes a pair of laterally offset recesses 621 and 622 in an outer surface portion 623 of the spool body 601 connected by a camshaft-receiving opening (not shown) extending parallel to the central spool shaft 605 and off-centered relative to the spool body 601. The recesses including an integral spool stop portion 612. The recess 606 indicated in FIGS. 26-27, or other appropriately configured recesses integrally molded into spool body 601, may be used to retractably stow a torque tool (not shown in these views), which is useful for tightening the tension of the take-up reel assembly 300, aboard the applicator device 100, as described and shown in more detail below in connection with discussions of FIGS. 34-38.

As indicated in FIG. 28, the eccentric cam 602 includes a cam stop 610 (and similarly cam 6021 includes a similar cam stop). The cam stop 610 and spool stop 612 are adapted to abut to prevent the eccentric cam 602 from collapsing in the clockwise rotational direction. As shown in FIGS. 26-27, a smooth static dissipative plastic spacer disc 111 also may be provided with a central opening fitted around the tape supply spool assembly 600 and interposed between the frame and tape supply spool assembly/tape roll for purpose of preventing adhesion between the roll and the applicator body 101.

Referring to FIG. 29, the spool assembly 600 is shown in the expanded position holding a roll of tape 900 with tubular core 907. An optional flange 608 may be provided on the spool body 601 to provide supplemental protection against the roll 900 sliding axially off the spool assembly 600. The end of the cam handle 604, having been rotated into the expanded position, also overhangs the roll 900, helping to keep the roll 900 in place.

Referring to FIG. 30, two independent mechanisms help to prevent the spool assembly 600 from unintentionally collapsing under the pressure of the tubular core 907. First, the cam(s) 602 are arranged such that the clockwise torque transmitted from the core 907 to the spool assembly 600 during tape 901 unwinding tends to bias the cam(s) 602 clockwise toward their open, expanded position. As indicated, abutting cam and spool stops prevent the cam(s) from collapsing in the clockwise direction. Secondly, the expanded position of the cam(s) 602 is 10 degrees past top dead center, such that the hoop pressure of the core 907 tends to force the cam(s) 602 clockwise against the open stops rather than counter-clockwise towards the collapsed position. To collapse the spool assembly 600, counterclockwise torque is applied. In particular, to collapse, the camshaft 602 must rotate counter-clockwise past top dead center, stretching the core 907 in the process. This may be readily accomplished by turning the handle 604 (e.g., see FIGS. 29, 31), but otherwise the system is stable in the expanded position.

Referring to FIG. 31, an illustration is provided of how the roll 900 can be loaded over the optional spool flange 608. The roll 900 is installed in the position shown such that the inner diameter of the core 907 clears the flange 608 and the collapsed cam(s) 602. Once the core is past the flange 608 in the axial direction, it may be slid leftward under the flange and the cam(s) 602 rotated to the expanded position using handle 604 to hold the roll 900 in place, as shown in FIG. 30.

The collapsing tape spool assembly may be utilized on any device that stores, dispenses, or applies tape, rope, film, or other flexible material wrapped around a tubular core. When expanded, the spool assembly holds the core in the axial direction and transmits torque between the core and the spool, enabling the unrolling action of the flexible material to drive a shaft attached to the spool. For example, unwinding tape from the core drives rotation of the spool, which drives a gear train to turn the tape liner take-up reel assembly.

The tape spool assembly makes it easier and faster for a user to reload (removing a spent core and replacing it with a full roll) than a standard non-collapsing press-fit-type spool. With prior press-fit types of spools the user must supply a significant force to overcome the press fit when loading or unloading the tape roll to/from the spool. The collapsing nature of the tape spool assembly of this embodiment eliminates this force, which enables faster and easier reloading of the tape applicator. The reduction of the required installation/removal force makes it easier for a user to unload/remove a spent core and reload a new full tape roll, especially when a user is standing on a ladder, a steeply pitched roof, etc.

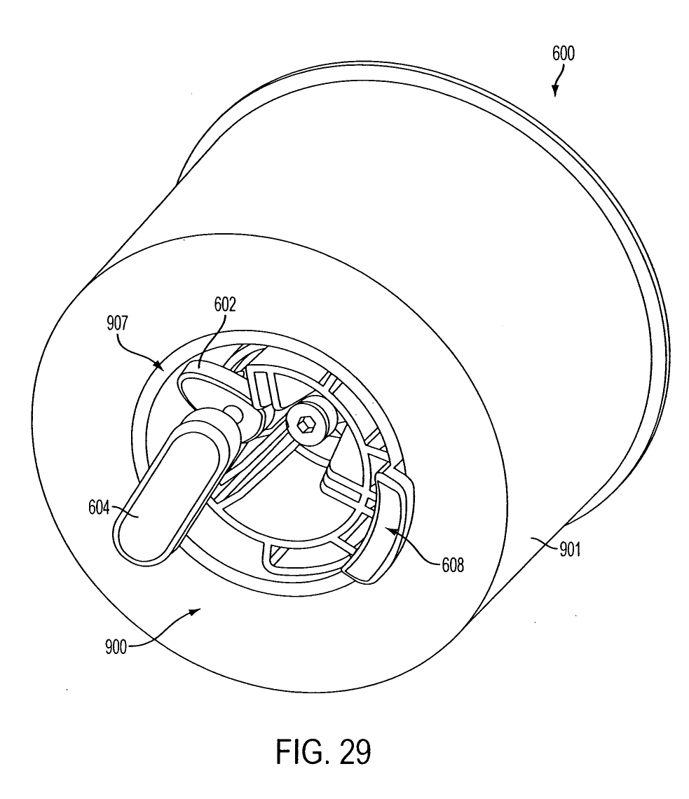

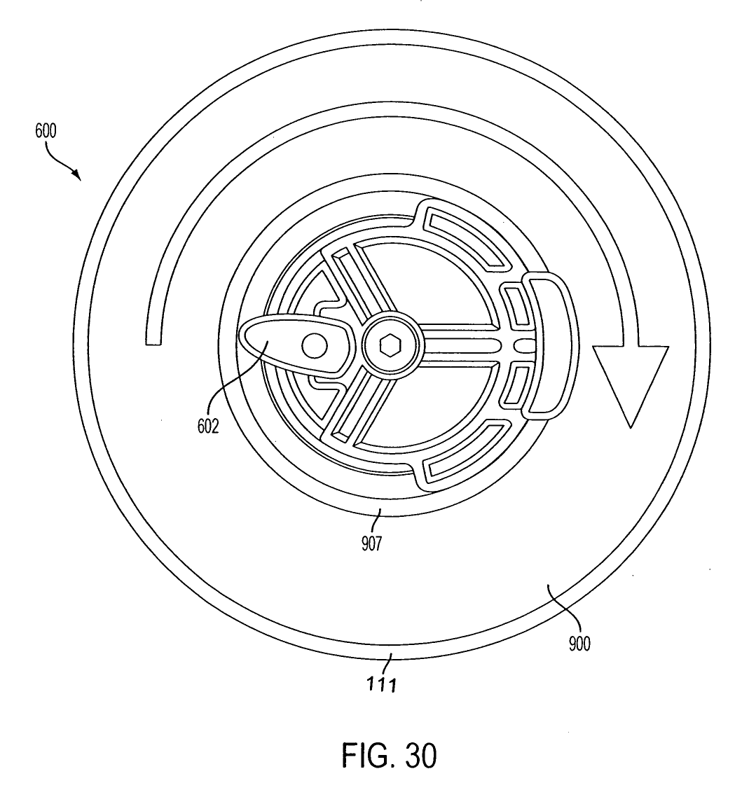

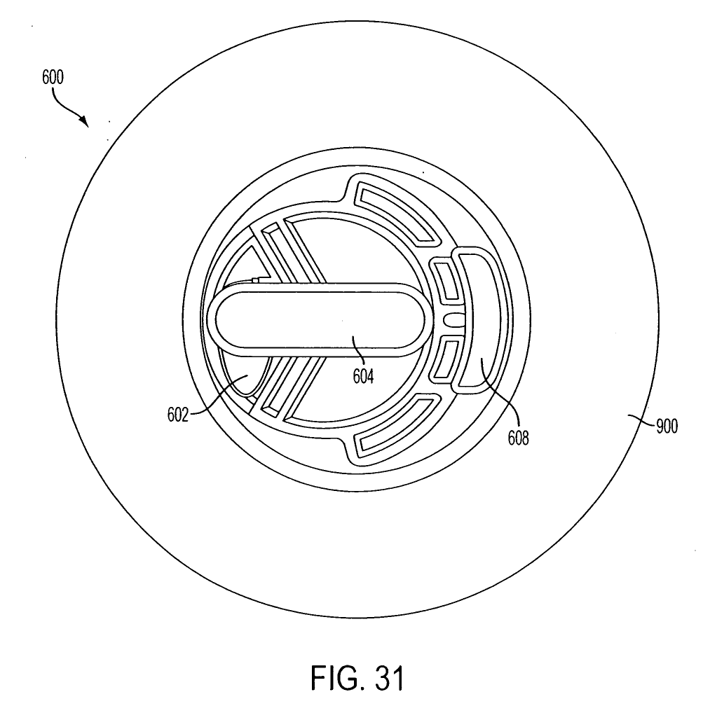

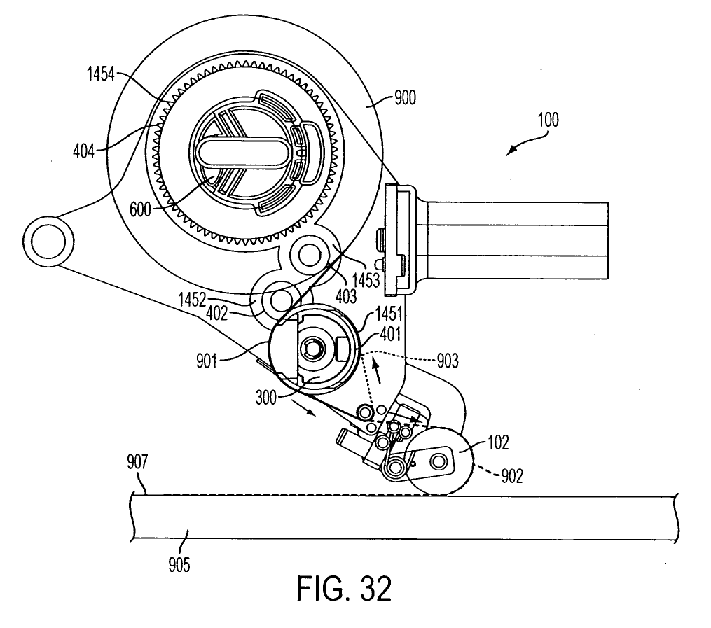

Regarding other components and assemblies of the device 100, the side frame 101 is unitary and relatively rigid part. Frame 101 may be, for example, a cast or stamped metal part, or a shaped or molded composite material or ceramic material, etc. For instance, the device 100 may be a cast aluminum or steel frame plate, used together with plastic rollers, tape wells, and gears. Integral circular recesses 1451 to 1454, such as indicated in FIG. 32, having depth and diameter accommodating associated gears of gear assembly 400 are provided for rotatably mounting the respective drive gears within the side frame 101, which open into each other at their axial (lateral) sides such that the gears 401 to 404 can be intermeshed at those locations while still being retained within the respective frame recesses

As illustrated in FIG. 32, the device 100 is operable in manner that allows an adhesive layer 902 of an adhesive tape material 901 to be transferred onto a surface 907 of a substrate 905 while a protective release liner 903, which separates successive wound layers of adhesive layer on the wound supply roll of tape 900 mounted on tape spool assembly 600, is collected around take-up reel assembly 300. The tape roll 900 generally may be a conventional configuration with a strip of adhesive material successively wrapped around a hollow circular core adapted to be releasably fitted upon tape spool assembly 600. The device 100 also may be used to apply non-lined single-sided adhesive tape material to a substrate, wherein there is no need to use a take-up reel assembly 300 to collect spent liner. As adhesive tape is applied and stuck to surface 907 as applicator device 100 is pulled across the surface 907, tension is created in adhesive tape 901 creating a torque force on supply spool assembly 600, causing it to rotate and unreel more tape. Rotation of tape spool assembly 600, in turn, causes rotation of take-up reel assembly 300 so that it can simultaneously and automatically collect more spent liner via drive means 400 described in greater detail below. The effective outer diameters of the supply tape spool assembly 600 and the take-up reel assembly 300 are constantly changing as the adhesive tape material 901 is unwound from a tape roll 900 mounted for rotation on tape spool assembly 600, and adhesive layer 902 is deposited on substrate 905 and the spent release liner 903 is collected on the take-up reel assembly 300. For instance, in a tape applying operation such as for building construction, the effective diameter at the tape spool 600 is relatively large initially and progressively decreases as supply tape is paid out during tape application using device 100 while the spent liner wraps around and accumulates on the tape reel assembly 300 such that its effective diameter progressively increases. The ideal mechanical drive ratio needed between the tape spool assembly 600 and take-up reel assembly 300 thus generally will vary as the effective sizes of the rolls on the spool and reel varies during a tape dispensing operation using applicator device 100.

Still referring to FIG. 32, the gears 1454, 1453, 1452 and 1451 are illustrated in this example as comprising gear wheels having gear teeth extending around their circumferences. The gears are rotatably seated in their respective recesses provided in the side frame 101 such that gear teeth of adjacent gears intermesh. As shown by the indicated directional arrows, rotation of the supply spool assembly 600 causes rotation of its associated drive gear 1454 which in turn rotates the take-up reel assembly gear 1451 through the drive means 400. The two intervening idler gears 1452 and 1453 transmit the rotational force of the tape spool drive gear 1454 to the take-up reel assembly gear 1451. Although not required, the provision of an even number of idler gears (e.g., 2, 4, 6, etc.) allows the rotational direction of the supply spool assembly 200 to be reversed as transmitted through the gear train to the take-up reel assembly 300 so that it can automatically wind-up liner as the supply spool assembly unreels fresh tape. The idler gears also help provide clearance on the frame between the supply spool assembly and the take-up reel assembly. The drive means 400 provided in device 100 allows the angular rotational speed of the release liner take-up reel assembly 300 to be automatically synchronized with angular rotation speed of said tape spool assembly 600. The drive gear 1454 is larger than the driven gear 1451 providing a mechanical transmission ratio such that the take-up reel assembly 300 is rotated at an angular speed as fast as, and preferably faster than, that of the supply spool assembly 600, so that occurrence of slack in the tape is reduced or prevented. Consequently, the adhesive tape and release liner remain taut and generally slack-free, but are not stretched to the point of rupture, as they are respectively unwound and/or rewound by applicator device 100.

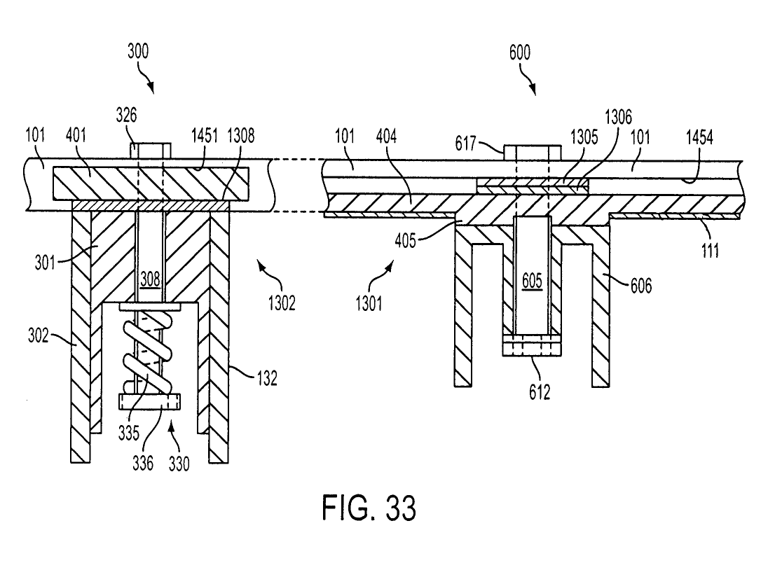

Referring to FIG. 33, an optional clutch system 1301/1302 for the device 100 is illustrated. A first clutch means 1301 is shown that is included in the tape spool assembly 600 operable to restrict the rotational speed thereof. A second clutch means 1302 is shown that is included in the take-up reel assembly 300 operable to restrict the rotational speed thereof and allow slip. As indicated, the effective outer diameters of the supply tape spool assembly 600 and the take-up reel assembly 300 constantly change as the adhesive tape 901 is unwound from a tape roll 900 mounted for rotation on tape spool assembly 600 and the spent release liner 903 is collected on the take-up reel assembly 300. In general, the tape spool gear 404 is sized larger in diameter than the reel gear 401 sufficient to provide a mechanical drive ratio between the tape spool assembly 600 and take-up reel assembly 300 which will ensure that the take-up reel assembly 300 is rotated at an angular speed which is the same or greater than that of the tape spool assembly 600 for all effective diameters of tape rolls and wound spent liner on device 100 during a tape application run or runs using a given tape roll. In this manner, the adhesive tape and liner are kept taut and generally slack-free, but are not over-tensioned or over-tightened.

Still referring to FIG. 33, clutch means 1301 includes a felt friction plate 1305 and an adjacent steel friction plate 1306 urged into contact with tape spool gear 404 via a tape spool shaft 605 rigidly attached to the backside of the frame 101 via lock washer 617. The spool body 601 is held in axial compression against the integral spool mounting pedestal 405 of gear 404 via tension adjustment knob 612 fitted onto an outer end of spool shaft 605, which in turn urges the gear 404 against friction plate 1306. The first clutch 1301 is operable to dissipate excess speed of rotation of the tape spool assembly 600 to reduce or prevent overstretching of the tape, and it also reduces or prevents self-tightening and tape spool slippage. Clutch means 1302 includes a friction plate 1308 urged into contact with take-up reel assembly gear 401 via spring biasing means 330 comprising helical spring 335 arranged on the reel shaft 308 rigidly attached to the backside of the frame 101 via lock washer 326. The spring 335 is held in compression against the take-up reel assembly base 301 via tension adjustment knob 336, which in turn urges the friction plate 1308 against gear 401, which effectively restricts the rotational speed of the gear but also allows for slip. The second clutch means 1302 in the take-up reel assembly allows the take-up reel assembly to slip so that it can move at the same angular speed as the tape spool while also being operable to dissipate excess speed of rotation of the take-up reel assembly to reduce or prevent overstretching of the liner and/or slippage of the take-up reel assembly in a rotational direction opposite to the wind-up direction which might lead to slack in the spent liner during tape application. The static dissipative shield 111 shown in the illustration of FIG. 33 does not affect the operation of the supply tape spool assembly 600 or clutch means 1301.

The hand grip 701 mounted to a base portion 104 of the frame 101 is operable to allow the device 101 to be held by a single hand of an operator. In one embodiment, the hand grip 701 is attached to the base portion 104 of the frame 101 at a position such that the center of gravity of the device 101 with a mounted tape roll is over the center of an operator's wrist. For instance, as indicated by the view of FIG. 1, the base portion 104 stands off the side frame 101 (i.e., towards the viewer in this perspective) at a generally perpendicular angle and supports the hand grip 701 directly underneath. Even if a relatively wide tape roll is mounted on tape spool assembly 600, the center of gravity of the device 100 generally still remains over the center of gravity of an operator's wrist, providing enhanced ergonomics and ease of operation. The user's free hand may be used to grasp horizontal grip handle 702 near the top of the device 100 for providing added pressure application control and tape application guidance.

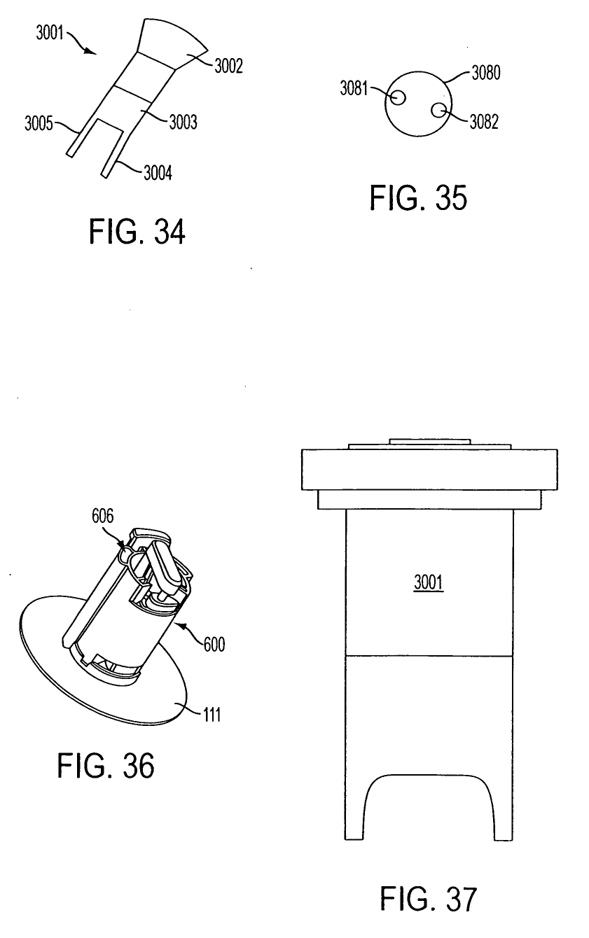

Referring to FIGS. 34-38, the applicator device 100 may further comprises a torque tool 3001 comprising a plurality of rigid posts 3004 and 3005 extending from a grippable piece 3002/3003. This torque tool 3001 may be a composite device or a homogenous construction. In the particular embodiment illustrated in FIGS. 34 and 37, torque tool 3001 includes a rigid metal body piece 3003 from which a pair of integral metal posts or other rigid posts 3004 and 3005 (although any number of two or more posts might be used) extend in fixed positions from one end thereof. A plastic or elastomeric grip piece 3002 is fixedly mounted or attached to the opposite side of the metal body 3003. As the take-up reel assembly loosens during extended use, tape liner gets slack and hangs down, which interferes with device operation. With normal wear and operation, the tension at the take up spool assembly therefore will occasionally need to be adjusted to maintain liner tension. Referring to FIG. 35, the torque tool is used to tighten (or loosen) the spring nut 3080 of the take up spool assembly 300. To perform this function, two or more holes 3081 and 3082 are formed in the spring nut 3080 of the take up spool assembly 300, which are configured to receive the two end posts 3004 and 3005 of the hand held torque tool 3001 to a depth permitting twisting force applied to the torque tool 3001 to be transferred to the spring nut 3080 to impart rotary movement to it. That is, after the posts 3004 and 3005 are inserted into the holes 3081 and 3082 in the spring nut 3080, the torque tool 3001 can be manually turned to turn the spring nut 3080 effective to tighten (or loosen) the spring nut, depending on the direction of manual turning of the torque tool 3001. The pattern of the plurality of posts provided on torque tool 3001 and corresponding holes in spring nut 3080 can be varied as long as torque force can be transferred therebetween as described. The torque tool 3001 eliminates the need to provide and use needle-nose pliers or other tools to tighten the take up spool assembly 300. The torque tool 3001 may have a rubberized top 3002 that can be used to store and lock the torque tool 3001 into place when slid into and retractably frictionally interfitted in an existing crevice 606 on the supply tape spool body 601 of the applicator device 100 (see FIGS. 26-27), such as illustrated in FIG. 36 and 38. In this manner, the torque tool 3001 can be conveniently stored and carried aboard the applicator device when not being used.

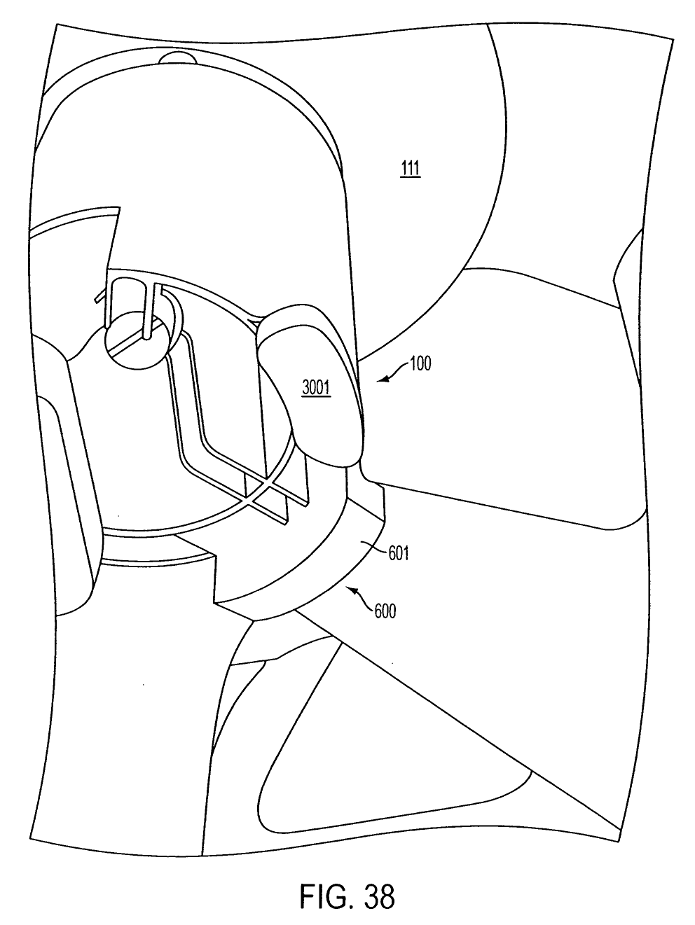

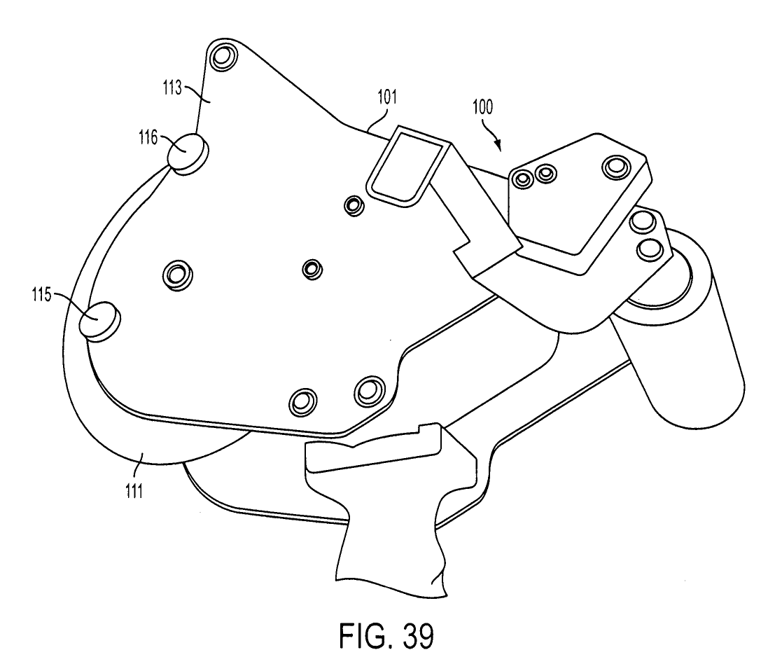

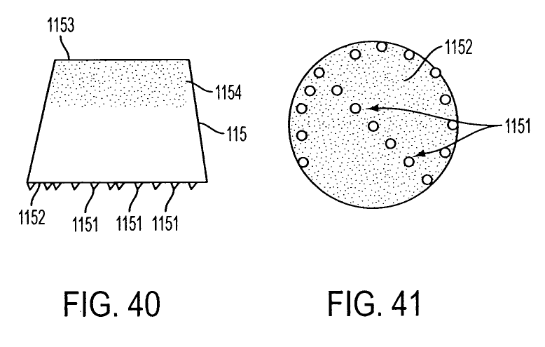

Referring to FIGS. 39-41, in another embodiment the applicator device 100 further includes a plurality of slip-resistant nubs 115, 116 integrally attached to and protruding from a side 113 of the frame 101 opposite the side 1090 upon which the take-up reel assembly and supply reel assembly are attached. The nubs 115 and 116 each have a closed outer end 1152 and an opposite open end 1153. The closed end 1152 comprises a generally flat surface from which a plurality of small spaced-apart integral projections 1151 extend to increase slip-resistance between the nub and a contacted surface, such as roof, if the device is 100 is briefly set down on a surface (nubs-side down). The nubs 115 and 116 may comprise composite structures including an elastomeric molding including the closed end 1152, and the opposite open end 1153 holds an internally-threaded nut 1154, which allows the nubs to be removably fitted to threaded bolt ends projecting through the frame 101. The nubs 115 and 116 help to immobilize the applicator device 100 in place if a user sets the device down on an inclined surface, such as a roof, as the nubs increase the slip-resistance of the device 100. Although two nubs are exemplified in this illustration, it will be appreciated that any number thereof can be provided subject to spatial limitations on the frame.

The device 100 has an applicator roller 102 that may have a smooth surface or relief surface. As illustrated in FIG. 1, the tape applicator device 100 may include a patterned pressure roller 102, also referred to herein as the applicator roller, in a preferred embodiment. As can seen in FIG. 2, the pressure roller 102 rotates on an axle 203 mounted to fork 204 and extension arm 210 on one lateral side and an applicator plate 2090 on the opposite lateral side thereof.

Referring to FIG. 42, it shows an exemplary, non-limiting surface pattern comprising a network 1000 of upraised portions 1001 defining diamond shaped recesses 1002 around the outer cylindrical periphery 1003 of the pressure or applicator roller 102.

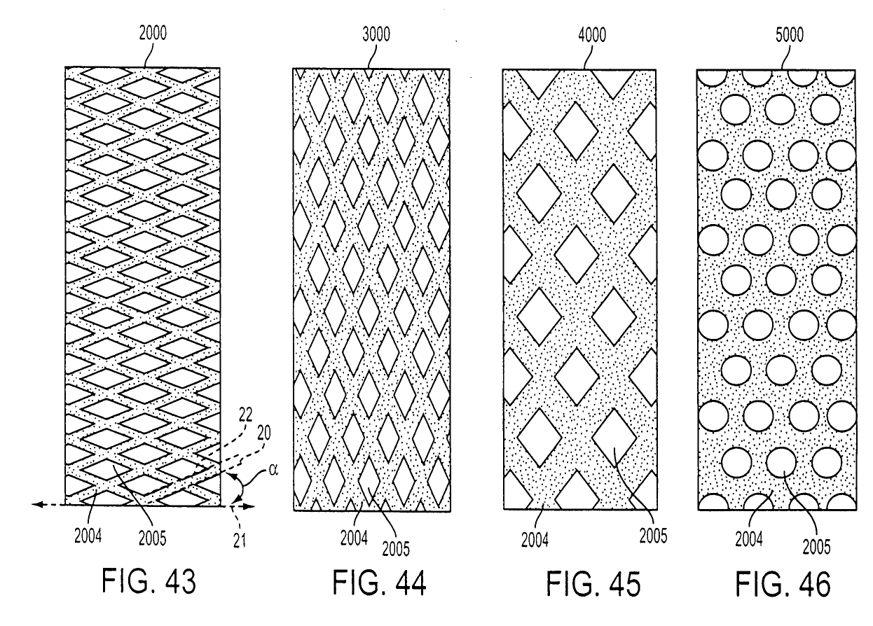

FIGS. 42-46 show several additional non-limiting surface patterns 2000, 3000, 4000, and 5000 respectively, that could be used on the surface of the pressure roller 102, where upraised portions 2004 are indicated by the gray regions and the recessed portions 2005 are indicated by white spaces. Preferred embodiments of the surface pattern are a network or lattice of diamond shapes such as shown in FIGS. 43 and 44, but are not limited thereto. The pattern shown in FIG. 45 is diamond pattern having relatively wider lines, increased line spacing, and line angles compared to the pattern of FIG. 43. Other patterns include circles (FIG. 46), etc.

The pressure roller 102 has an upraised pattern comprising upraised land areas which surround a plurality of isolated recessed areas which remain out of contact with a tape being applied with the pressure roller. The recessed portions have geometric shapes selected from the group consisting of diamond, circle, triangle, square, and hexagon, etc., and more particularly may comprise diamond shapes. In another particular embodiment, the upraised pattern comprises upraised portions forming a continuous network extending across an entire lateral width of the applicator roller. The network particularly may comprise a regular repeating pattern encircling the periphery of the applicator roller.

Referring to FIG. 43, the surface pattern 2000 provided on the applicator roller may have pattern angle α (alpha), which is measured between a leading edge 20 of a shape defining-upraised line or ridge and a horizontal line 21 that laterally traverses the peripheral cylindrical surface of the pressure roller and is parallel to the rotational axis of the pressure roller as indicated by hatched trace lines included in the figure. The trailing edge 22 of each upraised line generally extends parallel to the leading edge 20. For purposes herein, “vertical” refers to a direction along the circumference of the pressure roller, and “horizontal” means parallel to the rotational axis of the pressure roller. Referring to FIG. 44, the diamond shapes shown in FIG. 43 have been rotated 90 degrees in pattern 3000. It will be appreciated that recess shapes with an aspect ratio other than one (diamonds, ovals, rectangles, etc.) may be used on the surface of the pressure roller oriented with their long (major) axis parallel or perpendicular to the axis of rotation without altering the basic function of the invention.

The patterned pressure roller reduces the amount of force required to create a seal between an adhesive tape and a substrate surface to which the tape is applied by concentrating the application force in an upraised pattern. The upraised pattern provides reduced tape-contacting surface area at the outer periphery of a cylindrical roller, effective to keep relatively small applied user-applied forces focused at points of contact made between the upraised pattern and an underlying tape liner or tape. Even though the overall tape contacting area of the pressure roller is discontinuous and reduced, the patterned pressure roller can provide a better seal between seam tape and a substrate, as measured by water-seepage, on textured surfaces than smooth pressure rollers using similar or even more application pressure. It also has been observed that even though contact user-applied force made with a tape during transfer is limited to the upraised pattern portions of the pressure roller, that the adhesive coating or adhesive content of the adhesive tape thereafter tends to flow sufficiently to provide essentially continuous contact between a side of the tape and the substrate surface. In this manner, the tape gripping force can build with time after tape application using the patterned pressure roller.

In one embodiment, only about 1 to about 10 pounds user-applied force, particularly about 2 to about 6 pounds user-applied force, and more particularly about 2 to about 5 pound user-applied force, need be applied to the tape applicator device equipped with a patterned pressure roller of embodiments of the present invention to attach an adhesive tape to a substrate. This compares favorably with prior tape applicator systems requiring 20 or more pounds force for tape securement.

In addition, by isolating the recessed portions of the pattern with upraised portions on the pressure roller, the network forms barriers to water movement across the pattern. The network does not provide structural pathways for water to move through the network after tape application, helping to create a water resistant seal that prevents bulk water from entering the interior space during initial phases of construction. Substrate texture may also be an important consideration. In one embodiment, elements of the upraised roller pattern are angled relative to any directionality presented by the surface texture of the substrate. In one particular embodiment, the upraised portions of the roller pattern have a leading edge inclined at an intersecting angle relative to a texture presented by the substrate surface. This creates an improved seal against water intrusion.

In one embodiment, the total surface area of the upraised portions and the total area of the recessed portions is provided in a ratio of about 5:1 to about 1:10, and particularly about 3:1 to about 1:2, respectively. This ratio can be varied by changing the line width and line spacing of the upraised pattern or network on the surface of the pressure roller. The amount of contact area versus void area is an important factor in selection of the pattern for the pressure roller. The contact area determines the force needed to create the seal. For instance, if a smooth roller has 10 lbs. pressure applied on it and the roller has two square inch of surface area, then the pressure applied is 5 lbs./square inch. If, instead, the circumferential contact area of the roller is halved, such by providing an upraised surface pattern according to embodiments herein, then the total surface area of the roller would be reduced 50% to one square inch. If 10 lbs. of pressure is applied to that reduced surface area, then the panel will experience 10 lbs./square inch where the roller makes contact with the panel. Thus, application forces exerted on the tape are concentrated using the patterned pressure rollers of embodiments described herein.

In one embodiment, the applicator roll 102 of the applicator device 100 is comprised at least at its surface portions of a relatively hard yet resilient material having a Durometer hardness of between about 25 to about 70, particularly between about 30 and about 50. For a more textured substrate surface, the Durometer hardness of the applicator roll may be selected as a lower value than for a smoother substrate surface. A device applicator roller having the indicated hardness has sufficient flexibility and resiliency to allow an adhesive tape to better accommodate the topography of a substrate, especially uneven or textured surfaces. The adhesive tape can be applied in a manner making a water-resistant seal on uneven surfaces, such as gaps between structural components, with one pass or more of the applicator device. For example, the pressure applicator roller has a relatively low Durometer hardness but is sufficiently deformable in order to press a tape into crevices that are present on uneven surfaces, such as panels made of oriented strand board. The applicator roller also is firm enough to maintain enough nip pressure on the adhesive tape to provide secure bonding contact between the strip of adhesive tape and a substrate surface. The balance of resiliency and hardness provided in the pressure roller is important for providing a tight seal with a seam tape delivered by the applicator device onto a gap present between adjacent structural components, even if other structural features may be present in the tape delivery path which also introduce surface unevenness, i.e., roofing nails, metal joints, flashing, and so forth. For purposes herein, “Durometer hardness” refers to Shore A hardness unless indicated otherwise. The Shore hardness is measured using the ASTM test method designated ASTM D2240 00. The Durometer hardness values obtained from this test method are a useful measure of relative resistance to indentation of various grades of polymers.

In one embodiment, the pressure roller comprises two concentric portions including an inner, harder Durometer, generally cylindrical core portion and an outer, softer Durometer, patterned surface portion. The outer patterned portion may be formed on the core in a number of manners, such via casting techniques, or by wrapping and attaching (e.g., adhering) a pre-formed flexible patterned strip around the circumference of the core portion.

In one particular embodiment, patterned pressure rollers are made of polyurethane elastomeric with cores produced from castable urethane. Pressure rollers may be manufactured to have patterned surface portions having about 25 to about 70 Durometer. Modified nylon or other similar polymeric materials could also be used as a roller material. Other potentially useful materials for making the pressure rollers include synthetic and natural butyl rubber, and other elastomeric materials with a Durometer in the useful range.

The patterned pressure rollers may be manufactured by carving a full size model or master in wax or other material, then creating a form. Alternatively, a lathe could be used to impart a relief pattern in surface of the model. The form material is flowable and hardenable (e.g., hard rubber) or sinterable (e.g., ceramic) material that is filled in around the surface of the master and then solidified to form a negative of the pressure roller and the described surface pattern formed by the master. The form is a material selected to have a higher melting temperature than the wax master, such that the master can be removed by melting away the wax, and leaving the form. For example, a cylindrical pressure roller core of castable urethane or similar material is placed at a geometrically centered location inside the form. In one non-limiting embodiment, the pressure roller core is about 3.5 to about 4.5 inch in length and about 0.375 to about 0.625 inch in diameter. Then the gap present between the inside surface of the form and the outer surface of the hard roller core is filled with an elastomeric castable polymeric molding compound selected to have a desired Durometer value upon setting, and the molding compound is allowed to set. A suitable molding compound may comprise, e.g., urethanes, such as those available from Rotokinetics (Athens, Ga.) and other commercial suppliers. The form needs to be a different material than the surface material of the pressure roller, and generally also needs to be flexible/stretchable to facilitate removal from a finished roller. The form material may be a polymeric material having these attributes, such as hard natural or synthetic rubber, silicone, etc. If a polymeric form is used, a vacuum is broken between the mold and the finished roller, and the composite urethane roller can be pushed out of the form and is ready for use. For purposes of larger scale production of the pressure roller, conventional injection molding techniques can be adapted to make the component.

A specific embodiment of one preferred pressure roller has an approximately 30 Durometer polyurethane elastomeric surface with a castable urethane core with a diamond pattern. In one non-limiting embodiment, the pattern may have an average line width of about 0.13 to about 0.14 inch with diamonds having about 43 to about 47 degree angle (absolute value) at a density of about 2.5 to about 3.5 diamonds/inch vertical and about 2.0 to about 3.0 diamonds/inch horizontal.

Another embodiment of a preferred pressure roller has an approximately 30 Durometer polyurethane elastomeric surface with a castable urethane core with a diamond pattern. The pattern may have an average line width of about 0.07 to about 0.08 inch with diamonds having about 20 to about 25 degree angle at a density of about 2 to about 3 diamonds/inch vertical and about 0.75 to about 1.25 diamond/inch horizontal.

Yet another embodiment of a preferred pressure roller has an approximately 30 Durometer polyurethane elastomeric surface with a castable urethane core with a diamond pattern. The pattern may have an average line width of about 0.07 to about 0.08 inch with diamonds having about 20 to about 25 degrees angles at a density of about 3 to about 4 diamonds/inch vertical and about 1 to about 2 diamonds/inch horizontal. This embodiment is designed to be used with an application pressure of about 12.75 lbs. versus a tape manufacturer's recommendation of 20 lbs of application pressure.

It will be appreciated that the patterned pressure roller illustrated herein also can be implemented in other tape applicator systems, particularly those which offer an axle or rod for rotatably mounting the patterned pressure roller and means for feeding adhesive tape at least partially around the pressure roller sufficient for transfer pressure to be applied thereto, such as in lieu of a smooth-surfaced applicator roller mounted on such an axle or rod of the tape applicator. For example, the patterned pressure rollers of the present invention may be mounted and used on a hand-grippable adhesive tape applicator suitable for single-handed operation in building construction and other environments.

The handheld tape applicator 100 can handle a wide variety of tape widths, depending on the application, including but not limited to relatively large tape widths, such as up to about 8 inches or even more, depending on the scale of the assembled device and weight of the tape roll carried thereon. The applicator device 100 of embodiments herein similarly can accommodate a relatively large diameter roll of adhesive tape having a large strip length, which reduces the frequency of tape roll changes needed.

Before initiating a tape application operation with device 100, a roll of adhesive tape material 900 is mounted on the tape supply spool assembly 600 of device 100 (e.g., see FIG. 1). The adhesive tape may be an adhesive tape material comprising an adhesive layer or film (e.g., a moisture-resistant single-sided pressure-sensitive adhesive film) carried on a releasable backing or liner. In one embodiment, the release liner may have a thickness of about 4 mils, and the release backing and adhesive layer have a target thickness of about 12 mils. Optionally, the tape may have a backing of a thickness of about 1.0 mils to about 15 mils and an adhesive layer disposed on the backing of a thickness of about 2.0 mils to about 30.0 mils. The dry coefficient of friction for the tape is preferably at least about 0.6. Alternatively, the device 100 may be used to apply non-lined single-sided adhesive tapes. The device 100 is adapted to store, handle and apply relatively hefty spools of adhesive tapes. These adhesive tapes include, for example, a roll of adhesive tape material wound on a core part thereof which is mounted on the supply spool, wherein the tape adhesive material has a width of 2 to 8 inches and has a diameter of 3 to 10 inches, and an initial roll weight of up to about 20 pounds, particularly about 2 to about 10 pounds.

In one embodiment, to provide linear speed parity for the initial circumference of an about 7 to about 8 inch diameter tape roll mounted at the supply spool assembly 600 and an initial spent liner circumference on the take-up reel assembly 300 having a diameter of about 2.5 to about 3.0 inch, the device 100 incorporates a gear train 400 providing an initial mechanical ratio of about 2.5 to about 3.5 between the tape spool assembly 600 and take-up reel assembly 300.

To operate the tape applicator 100, an operator loads the tape onto the tape core mandrel with the tape unwinding in the clockwise direction. Then the release liner is fed into the take-up reel assembly for securing and winding the tape liner. To operate, the operator simply places the tape in the desired location and pulls the applicator towards himself/herself while applying pressure to the pressure applicator roller to “seat” the tape. When a desired length of tape has been applied, the tape is cut. This operation is repeated until all of the seams are covered.

In this general manner, the handheld applicator device 100 may be used in such a manner to apply strips of moisture-resistant seam tape to seal gaps or crevices associated with a building structure, such as abutting roofing panels, abutting wall panels, a window installation in a wall frame, a door installation in a wall frame, a plumbing vent installation in a roof, a skylight installation in a roof, and a dormer in a roof. The applicator device 100 makes it possible to apply seam, ridge and valley tape in building constructions applications with a handheld device instead of installing the tape by hand. This speeds up the construction process and avoids unwound release paper collecting around the work surface. For valley applications, an operator can run a strip of tape on one side of the seam where ⅓ to ¼ of the tape overlaps the seam. Then another strip is run on the other side of the seam with the same amount of tape overlapping. In this manner, the two pieces of tape comprise a “tape seam” of about 6 inch in width with tape sealing on panel and tape sealing on tape at the overlapping areas.

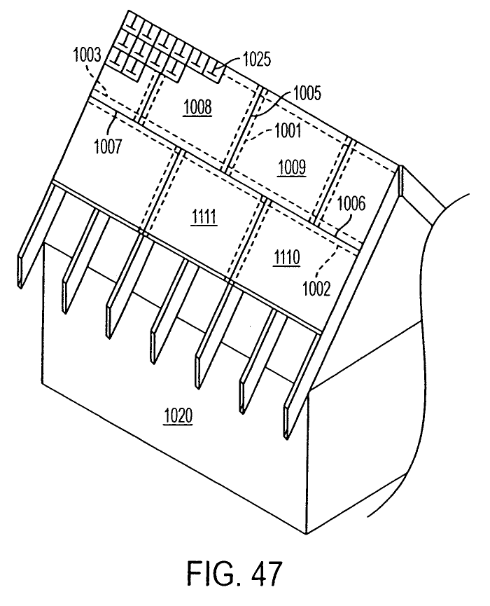

Referring to FIG. 47, the handheld applicator device 100 may be used to apply strips of moisture-resistant seam tape 1001, 1002, 1003, etc. (indicated by parallel hatched lines) to cover gaps 1005, 1006, 1007, etc., between adjacent structural panels 1008, 1009, 1010, 1011, etc., applied to a roof surface or frame 1020 before outer roofing coverage 1025 (e.g., shingles, shakes, slate, and metal) is applied thereover. The adjacent structural panels may have an integral water-resistant layer or coating on one or both major faces thereof. The seam tape protects the abutting edges of the adjacent panels. This method of applying seam tape with device 100 eliminates the need for the installation of felt paper or tar paper for roof construction.

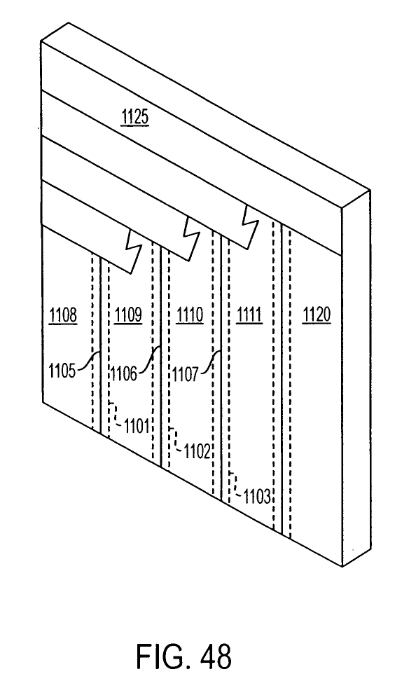

Referring to FIG. 48, the handheld applicator device 100 also may be used to apply strips of moisture-resistant seam tape 1101, 1102, 1103, etc. (indicated by parallel hatched lines) to cover gaps 1105, 1106, 1107, etc., between adjacent structural panels 1108, 1109, 1110, 1111, etc., applied to a wall surface or frame 1120 before outer wall coverage 1125 (e.g., siding) is applied thereover. The adjacent structural panels may have an integral water-resistant layer or coating on one or both major faces thereof. The seam tape again protects the abutting edges of the adjacent panels. This method of applying seam tape with device 100 eliminates the need for installing additional water impermeable membrane or other wall wraps for wall construction. The applicator 100 may also be used, for example, for the application of window flashing tape up to four inches in width with an outside diameter no greater than 7.75 inches.

In one preferred embodiment, a tape applicator according to embodiments herein is used to apply tape over the seams of abutting sheathing panels on a roof or wall. The sheathing panels have an overlay of resin-impregnated Kraft paper and a texture have been embossed into the surface of the overlaid sheathing panel. The texture has a pattern that generally runs in two directions; one along the length of the panel and the second along the width of the panel.

The roll of adhesive tape used needs to be wide enough to cover and seal the seams or gaps formed between abutting panels in such building construction applications, but not too wide to hinder application. It generally may be about 2 inches or wider, but typically not wider than 36 inches, with 2 to 8 inches being a preferred range for many applications. For wider tapes, a “push” application method may be better than a pull application method. Two examples of water-resistant seam tape which may be used are PROGRIP 6038 tape made by 3M, St. Paul Minn., and B14 tape made by Tyco International.

Benefits of the tape applicator device of the present invention include, for example, the production of higher quality taped joints than traditional tape applicators. The pressure feedback informs and encourages the user to apply appropriate pressure. The pressure feedback embodiments of the tape applicator of the invention are ways of generating increased sound volume from an audible feedback mechanism. The static dissipative shield keeps the user from being shocked due to the buildup of static electricity. The stabilization brace keeps the pressure roller from becoming torqued, and thus prevents the tape from mistracking and not receiving application pressure. Therefore, the tape can be properly sealed across its entire width of application. The torque tool is a simple way of being able to adjust the tension of the take-up reel assembly to maintain proper tension on the tape liner. Without this embodiment, needle nose pliers or the like would be needed to adjust the round nut. Needle nose pliers do not grip the round nut well. The slip resistant nubs keep the pressure sensitive tape applicator from sliding off of an inclined roof or other structure being worked on if a user briefly sets the applicator down. This helps to keep the applicator free of damage were it to drop from a roof. These advantages and benefits of the application device of the present invention are merely exemplary.

While the invention has been particularly described with specific reference to particular process and product embodiments, it will be appreciated that various alterations, modifications and adaptations may be based on the present disclosure, and are intended to be within the spirit and scope of the present invention as defined by the following claims.

What is claimed is:

1. A device for applying an adhesive tape material to a substrate, comprising:
a frame extending in a longitudinal direction;
an applicator roller assembly including an applicator roller rotatably mounted to said frame and extending generally transverse to said longitudinal direction, adapted to press adhesive tape material comprising an adhesive layer carried on a release liner against a substrate;
a tape supply spool assembly rotatably mounted to said frame, adapted to support a roll of the adhesive material, and unreel adhesive material to the applicator roll as the applicator roll moves against a substrate with the adhesive layer in contact therewith;
a release liner take-up reel assembly rotatably mounted to said frame, adapted to take-up the release liner after separation from the adhesive layer;
a gear train drivingly connecting the tape supply spool assembly and release liner take-up reel assembly;
a first hand grip mounted to a base portion of the frame;
a stabilization brace, extending in a direction generally parallel to and laterally spaced from said longitudinal direction of the frame, connecting (a) a first lateral side of the applicator roller assembly located opposite the second lateral side thereof located nearest the frame to (b) the base portion of the frame;
a pressure feedback assembly including a reciprocally translatable interference component operable to interact with a gear associated with the gear train to generate noise when pressure applied at the applicator roller is below a predetermined threshold pressure and to cease interaction with the gear and noise generation when the threshold pressure is met or exceeded.

2. The device of claim 1, wherein the interference component projects towards and reciprocally between gear teeth of a gear driving the take-up reel assembly, which interference component is supported from an extension arm extending in a direction towards the pressure roller, wherein interaction of the interference component and gear teeth generates an audible signal unless pressure force applied at the applicator roller meets or exceeds the predetermined threshold pressure.

3. The device of claim 1, the interference component comprises a rectilinear member having a rounded distal tip extending at an approximately 90 degree angle relative to recesses between adjacent gear teeth of a gear of the gear train which drives the take-up reel assembly.

4. The device of claim 3, wherein said rectilinear member is operable to generate an audible sound of least 75 decibels from interaction with gear teeth of the gear when the pressure roller is operated at below the threshold pressure.

5. The device of claim 3, wherein said rectilinear member comprises an aluminum plate member having a thickness of about 0.5 to about 0.8 mm and having a rounded distal end.

6. The device of claim 1, wherein the pressure feedback assembly comprises an idler gear drivable in rotation by a gear driving the take-up reel assembly the drive means and including a reciprocally translatable interference component operable to interact with the idler gear to generate noise when pressure applied at the applicator roller is below the predetermined threshold pressure and to cease interaction with the idler gear and noise generation when the threshold pressure is met or exceeded.

7. The device of claim 1, wherein the stabilization brace comprises a downward swept portion along its main body between its connected opposite ends effective to permit access to the take-up reel assembly.

8. The device of claim 1, further comprising a static dissipative polymeric sheet member encircling the supply tape reel assembly and located between the supply tape/fed tape and the frame, wherein the polymeric sheet member has a resistivity effective to prevent discharge to/from proximate human contact.

9. The device of claim 8, wherein the polymeric sheet member comprising acrylonitrile-butadiene-styrene surface-coated or filled throughout with an antistatic filler in amount effective to provide a resistivity of between about 10⁶ to about 10⁹ ohms per square.

10. The device of claim 1, further comprising a torque tool comprising a plurality of rigid posts extending from a grippable piece, and said torque tool stowable within a recess provided in the supply roll reel assembly, and wherein the take-up reel assembly further comprises a spring nut including a plurality of holes in a pattern adapted to receive said plurality of posts of the torque tool, wherein the torque tool is manually insertable via its posts into the spring nut holes and the torque tool is operable to adjust the rotational tension of the take-up reel assembly via exertion of manual rotation force on the inserted torque tool.

11. The device of claim 1, further comprising slip-resistant nubs integrally attached to and protruding from a side of the frame opposite the side upon which the take-up reel assembly and supply reel assembly are attached.

12. The device of claim 11, wherein the nubs have a closed end and an opposite open end, wherein the closed end comprises a generally flat surface from which a plurality of small integral projections extend to increase slip-resistance between the nubs and a contacted surface.

13. The device of claim 11, wherein the nubs comprise composite structures including an elastomeric molding including the closed end, and the opposite open end holds a threaded nut which allows the nubs to be removably fitted onto threaded bolt ends projecting through the frame.

14. The device of claim 1, further comprising a second hand grip mounted at a top portion of said frame generally opposite to the first grip, wherein the first hand grip comprises a first grip body oriented generally perpendicularly to a rotational axis of the tape spool, and the second hand grip comprises a second grip body generally oriented parallel to the rotational axis of the tape spool.

15. The device of claim 1, wherein the pressure feedback assembly comprises:
a fork rotatably mounted via a shaft to an applicator plate which is rigidly mounted to the frame;
a rod for rotatably mounting the applicator roller to the fork;
torsion springs arranged on the fork shaft, wherein the torsion springs are operable to normally bias the fork for pivotal movement in a first rotary direction;
an extension arm attached to the fork for joint pivotal movement with the fork, and an end portion of the extension arm includes the interference component operable to releasably contact gear teeth of the gear when at rest and during rotation thereof when user-applied force to the applicator roller is below a predetermined threshold value, effective to generate an audible signal during rotation of the gear component, and wherein the fork is rotatable in a second rotary direction opposite to said first rotary direction, and the feedback assembly operable for pivoting the end portion of the extension arm away from the gear component to move the interference component out of contact with the gear teeth when user-applied force to the applicator roller at least equals the pre-determined threshold level, effective to discontinue the audible signal.

16. The device of claim 1, wherein the device further includes a roll of adhesive tape material mounted on the supply spool assembly, wherein the roll comprises an adhesive layer comprising a moisture-resistant single-sided pressure-sensitive adhesive film carried by a liner.

17. The device of claim 1, wherein the device further includes a roll of adhesive tape material mounted on the supply spool assembly, wherein the tape adhesive material has a width of 2 to 8 inches and has a diameter of 3 to 10 inches, and an initial roll weight of about 2 to about 10 pounds.

18. A method of constructing a building structure, comprising:
(A) providing a roofing or wall frame;
(B) fastening a plurality of structural panels having an integral moisture barrier in an abutting arrangement onto the frame with fastening means;
(C) covering a gap formed between the abutting structural panels with a water-resistant seam tape using a tape applicator device, wherein the tape applicator device comprises:
a frame extending in a longitudinal direction;
an applicator roller assembly including an applicator roller rotatably mounted to said frame and extending generally transverse to said longitudinal direction, adapted to press adhesive tape material comprising an adhesive layer carried on a release liner against a substrate;
a tape supply spool assembly rotatably mounted to said frame, adapted to support a roll of the adhesive material, and unreel adhesive material to the applicator roll as the applicator roll moves against a substrate with the adhesive layer in contact therewith;
a release liner take-up reel assembly rotatably mounted to said frame, adapted to take-up the release liner after separation from the adhesive layer;
a gear train drivingly connecting the tape supply spool assembly and release liner take-up reel assembly;
a first hand grip mounted to a base portion of the frame;
a stabilization brace, extending in a direction generally parallel to and laterally spaced from said longitudinal direction of the frame, connecting (a) a first lateral side of the applicator roller assembly located opposite the second lateral side thereof located nearest the frame to (b) the base portion of the frame;
a pressure feedback assembly including a reciprocally translatable interference component operable to interact with a gear associated with the gear train to generate noise when pressure applied at the applicator roller is below a predetermined threshold pressure and to cease interaction with the gear and noise generation when the threshold pressure is met or exceeded;
(D) applying an outer roofing or wall coverage on at least a portion of the abutting structural panels, without applying a felt layer before applying the outer roofing or wall coverage.

19. The method of claim 18, wherein the pressure feedback assembly generates an audible signal of at least about 75 decibels when the force applied at the pressure roller is below the predetermined threshold pressure.

20. A method for sealing gaps or crevices associated with a building structure selected from the group consisting of abutting roofing panels, abutting wall panels, a window installation in a wall frame, a door installation in a wall frame, a plumbing vent installation in a roof, a skylight installation in a roof, and a dormer in a roof; by applying a seam tape to cover the gap or crevice using the device of claim 1.
